(19) United States
(12) Patent Application Publication
(10) Pub. No.: US 2019/0340344 A1
(43) Pub. Date: Nov. 7, 2019

(54) INPUT/OUTPUT INTEGRATION MODULE FOR SIMULTANEOUSLY LINKING BIOLOGICAL INFORMATION ALGORITHMS

(71) Applicant: ALL IT TOP CO., LTD., SEOUL (KR)

(72) Inventors: Sung Ho CHOI, Uiwang-si (KR); Chung Ja SONG, Uiwang-si (KR); Dae Jin PARK, Seoul (KR); Woo Kyoum KIM, Jinju-si (KR)

(21) Appl. No.: 16/462,259

(22) PCT Filed: Nov. 13, 2017
(86) PCT No.: PCT/KR2017/012814

§ 371 Date: May 20, 2019

(30) Foreign Application Priority Data
Nov. 18, 2016 (KR) 10-2016-0153836
Nov. 24, 2016 (KR) 10-2016-0157310
Nov. 24, 2016 (KR) 10-2016-0157311

(51) Int. Cl. G06F 21/32; G06F 13/42

(52) U.S. Cl. CPC G06F 21/32; G06F 2213/0042; G06F 2213/0002; G06F 13/4286

(57) ABSTRACT

Provided is an input and output integrated module for simultaneously linking biometric information algorithms, which includes an integrated module for simultaneously authenticating fingerprints and finger veins which includes a fingerprint module, a finger vein module, and a conversion module, wherein: the fingerprint module scans a fingerprint in an image sensor, compares the scanned image with a previously-stored image, and outputs a registered authentication code of a corresponding person as a specific serial communication signal when there is a person having a fingerprint identical to the previously-stored image; the finger vein module scans a finger vein in a camera image sensor after light of an infrared light-emitting diode passes through a finger, compares the scanned image with a previously-stored image, and outputs a registered authentication code of a corresponding person as a specific serial communication signal when there is a person having a finger vein identical to the previously-stored image.

### CROSS-REFERENCE TO RELATED APPLICATIONS

This application claims priority to PCT Application No. PCT/KR2017/012814, having a filing date of Nov. 13, 2017, which is based upon and claims priority to KR Application No. 10-2016-0157311, having a filing date of Nov. 24, 2016, KR Application No. 10-2016-0157310, having a filing date of Nov. 24, 2016, and KR Application No. 10-2016-0153836, having a filing date of Nov. 18, 2016. The entire contents of all priority documents are incorporated herein by reference.

### FIELD OF TECHNOLOGY

The following relates to an input and output integrated module for simultaneously linking biometric information algorithms, and more particularly, to an input and output integrated module for simultaneously linking fingerprint and finger vein algorithms, which is applied to a polyhedral stereoscopic imaging device for simultaneously authenticating fingerprints and finger veins and has been devised to be applied to the National Intelligence Service and financial transaction systems that require extremely high security by simultaneously authenticating the fingerprints and finger veins in combination.

The polyhedral stereoscopic fingerprint and finger vein imaging and authentication device is a technology of a device that further authenticates finger veins in addition to fingerprints using two fingers by separating males and females so that uniqueness of an individual's biometric information is better maintained than in a conventional authentication environment, thereby securing a new financial technology (fintech).

### BACKGROUND

Biometric information that is unique to each individual has an advantage in that it cannot be separated from each individual.

In the case of fingerprint recognition, frequent recognition errors such as those in a case in which a finger is wet or stained with a foreign substance or a case in which finger skin is damaged or deformed have been pointed out, and there has been a problem in that a fingerprint surface is easy to forge and duplicate.

A false acceptance rate of fingerprint recognition is about 5%. For example, about five out of a hundred fingerprints are falsely accepted.

Meanwhile, in the iris recognition technology, recognition fails or takes a long time in cases in which one is wearing color contact lenses or has received Laser-Assisted In-Situ Keratomileusis (LASiK) surgery or Laser-Assisted Sub-Epithelial Keratectomy (LASEK) surgery, and a problem in that an error may occur depending on a distance and an angle has been pointed out.

A finger vein authentication technology has been known as biometric information that is superior in terms of all aspects such as resistance to forgery and falsification, false acceptance rate, false rejection rate, failure to enroll rate, and authentication time as compared to the above-described biometric technologies.

The finger vein authentication technology is a technology in which vein patterns are recognized by transmitting near infrared light through a finger. The finger vein authentication technology has advantages in that forgery and falsification are impossible because blood vessels in fingers are authenticated and that finger vein patterns of a dead person may be utilized when necessary.

In the finger vein authentication technology, a hardware device technology in which a finger vein image is acquired using a charge-coupled-device (CCD) camera and a software technology in which a finger vein image is filtered or vein patterns are extracted from a finger vein image and computed are combined using a pattern processing program.

However, the finger vein authentication device has two weaknesses, one of which is that there is still a possibility of false acceptance. It is known that the same finger vein pattern is recognized from one per a hundred thousand people or one per a million people according to a finger vein processing algorithm. Therefore, despite the superiority of the finger vein authentication technology, there has been a weakness in that accurate user authentication cannot be performed by using only the finger vein patterns in the case of two people whose two-dimensional finger vein patterns in fingers are similar.

The second weakness is that, when comparing two finger vein images, the comparison should be performed after superimposing the two finger vein images so that two finger vein patterns almost exactly overlap each other. That is, since similarities between blood vessels of two finger vein patterns are determined based on relative coordinates instead of absolute coordinates, this may act as a deviation factor that hinders accurate recognition.

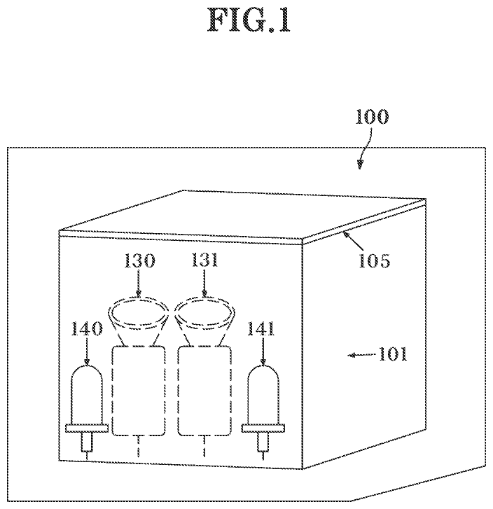

To address such problems, a technology shown in FIG. 1 has been devised.

As shown in FIG. 1, a scan panel 105 which is made of a transparent material such as glass or acryl is provided at an upper portion of an object accommodating portion 101. A user places a finger object on the scan panel 105 to start finger vein authentication. Upon start of finger vein authentication by the device, an infrared light source 140 and a visible light source 141 irradiate the finger object with infrared light and visible light.

Then, a CCD infrared light camera and a CCD visible light camera respectively capture images of finger veins and fingerprints which have been irradiated with the infrared light and the visible light.

In a device 100 of the related art, two CCD cameras 130 and 131 are embedded therein.

A finger vein camera 130 is provided to be embedded in the object accommodating portion 101 and captures an image of finger veins of the object facing the scan panel 105. In addition, almost simultaneously, a fingerprint camera 131, which is provided in the same object accommodating portion 101, captures an image of a fingerprint of the object.

The infrared light source 140 emits infrared light toward the object accommodating portion. The infrared light source 140 may include one or more light-emitting diodes (LEDs) and emit infrared light having a wavelength of 630 to 1,000 nm that is suitable for capturing a finger vein image. In addition, an optical filter may be provided in the infrared light source 140 and filter optical noise.

The visible light source 141 emits visible light toward the object accommodating portion. The visible light source 141 may include one or more LEDs and emit ultraviolet light having a wavelength suitable for capturing an image of a fingerprint on a surface of a finger.

In addition, in an exemplary embodiment of the related art, a single infrared light source 140 configured to radiate infrared light toward an object accommodating portion and a single visible light source 141 configured to radiate visible light toward the object accommodating portion may be provided.

Further, in an exemplary embodiment of the related art, the finger vein camera 130 acquires finger vein images of two finger objects.

However, even when authentication is performed by a finger vein authentication device using two fingers, the possibility of false acceptance, which is the first weakness, and the problem in that, when determining similarities between two finger vein images, the two finger vein images should be compared after superimposing the two finger vein images so that two finger vein patterns almost exactly overlap each other, which is the second weakness, still exist, and there is also a problem in that it is not possible to cover a false acceptance rate of only one finger vein pattern.

Furthermore, the finger vein authentication technology is known as biometric information that is superior in terms of all aspects such as resistance to forgery and falsification, a false acceptance rate, a false rejection rate, a failure to enroll rate, and authentication time as compared to the above-described biometric technologies.

The finger vein authentication technology is a technology in which vein patterns are recognized by transmitting near infrared light through a finger. The finger vein authentication technology has advantages in that forgery and falsification are impossible because blood vessels in fingers are authenticated and finger vein patterns of a dead person may be utilized. However, there is a problem in that one per ten million or more people may have the same finger vein pattern.

### SUMMARY

An aspect relates to an authentication method capable of significantly improving a false acceptance rate of finger veins, decreasing a false acceptance rate of fingerprints by simultaneously authenticating fingerprints and finger veins, decreasing errors in determining similarities between blood vessels of finger veins, and easily recognizing human body information of a person even by using only one finger.

Further, aspects of embodiments of the present invention are to increase an authentication determination speed and facilitate manufacture of authentication determination equipment by reducing recognition rates of fingerprints and finger veins to narrow an error range related to the finger print recognition rate or finger vein recognition rate when a combination of fingerprints and finger veins are used to determine whether a user is authenticated.

In addition, aspect of embodiments of the present invention are to develop an integrated module for simultaneously authenticating fingerprints and finger veins.

### Technical Solution

One aspect of embodiments of the present invention provides an input and output integrated module for simultaneously linking biometric information algorithms, which includes an integrated module (U1) for simultaneously authenticating fingerprints and finger veins which includes a fingerprint module (U2), a finger vein module (U3), and a conversion module (U4), wherein: the fingerprint module (U2) scans a fingerprint in an image sensor, compares the scanned image with a previously-stored image, and outputs a registered authentication code of a corresponding person as an RS232 serial communication signal when there is a person having a fingerprint which is identical to the previously-stored image; the finger vein module (U3) scans a finger vein in a camera image sensor after light of an infrared light-emitting diode (LED) passes through a finger, compares the scanned image with a previously-stored finger vein image, and outputs a registered authentication code of a corresponding person as an RS485 serial communication signal when there is a person having a finger vein which is identical to the previously-stored image; and the conversion module (U4) receives an RS485 communication signal output from the finger vein module to convert the RS485 communication signal into an RS232 communication signal as in the fingerprint module (U2) and output the converted RS232 communication signal, and receives a fingerprint authentication code output from the fingerprint module (U2) and a finger vein authentication code output from the finger vein module (U3) to output a corresponding authentication code via Universal Serial Bus (USB) when the fingerprint authentication code matches the finger vein authentication code.

In the fingerprint module (U2), a GND line 1 is a (−) voltage circuit, an RX line 2 is a serial data reception port, a TX line 3 is a serial data transmission port, and a VCC line 4 is a (+) voltage reference of the power supply circuit and, by using the GND line 1, the RX line 2, the TX line 3, and the VCC line 4, a fingerprint is scanned in the image sensor and the scanned fingerprint image is compared with a previously-stored image, and when there is a person having a fingerprint which is identical to the previously-stored image, a registered authentication code of the person is output as an RS232 communication signal.

In the finger vein module (U3), a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in the conversion module (U4), a GND line 1 at a left side is a (−) voltage reference, an A line 2 is a serial communication standard RS485 communication A port, a B line 3 is a serial communication standard RS485 communication B port, a VCC line 4 is a (+) voltage reference, a DI line 5 at a right side of the conversion module (U4) which is linked with the finger vein module (U3) is an RS232 serial communication reception port, an RE line 6 is an RS485 communication control port, a DE line 7 is an RS485 communication control port, and an RO line 8 is an RS232 serial communication transmission port.

In the integrated module (U1), a D1/TX line 1 is an RS232 serial communication transmission port, a DO/RX line 2 is an RS232 serial communication reception port, a GND line 4 is a (−) voltage reference, a D2 line 5 is an RS232 serial communication transmission line of the fingerprint module (U2), a D3 line 6 is an RS232 serial communication reception line of the fingerprint module (U2), a D8 line 11 is an RS232 serial communication transmission port of an RS485-232 communication conversion module (U4) and functions to control the finger vein module (U3), a D9 line 12 is an RS485 communication control port of the RS485-232 communication conversion module (U4), a D10 line 13 is an RS485 communication control port of the RS485-232 communication conversion module (U4), a D11 line 14 is an RS232 serial communication reception port of the RS485-232 communication conversion module (U4), a 5V line 27 is a PIN for outputting a voltage of +5 V, a GND line 29 is a (−) voltage reference, and a VIN line 30 is a (+) voltage reference and, by using the D1/TX line 1, the DO/RX line, the GND line 4, the D2 line 5, the D3 line 6, the D8 line 11, the D9 line 12, the D10 line 13, the D11 line 14, the 5V line 27, the GND line 29, and the VIN line 30, a fingerprint authentication code output from the fingerprint module (U2) and a finger vein authentication code output from the finger vein module (U3) are converted into RS232 communication signals in the conversion module (U4), the converted codes are received in the integrated module (U1), and when the fingerprint authentication code matches the finger vein authentication code, the corresponding authentication code is output via USB.

In addition, “fingerprintcode” and “fingerveincode,” which are arguments of a function “getfingerauthorization” of an algorithm with respect to a fingerprint authentication code and a finger vein authentication code are received, and when values of the two arguments are valid and unique numbers of the two registered customer match, a code number of a corresponding person is output in the integrated module for simultaneously authenticating the fingerprints and the finger veins.

Another aspect of embodiments of the present invention provides an input and output integrated module for simultaneously linking biometric information algorithms, which includes an integrated module (U1) for simultaneously authenticating Fingerprint 1 and Fingerprint 2 including a Fingerprint 1 module (U2) and a Fingerprint 2 module (U3), wherein: the Fingerprint 1 module (U2) scans a fingerprint in an image sensor, compares the scanned image with a previously-stored image, and outputs a registered authentication code of a corresponding person as a specific serial communication signal when there is a person having a fingerprint which is identical to the previously-stored image; and the Fingerprint 2 module (U3) scans a fingerprint in an image sensor, compares the scanned image with a previously-stored image to output a registered authentication code of a corresponding person as a specific serial communication signal when there is a person having a fingerprint which is identical to the previously-stored image, and receives a Fingerprint 1 authentication code output from the Fingerprint 1 module (U2) and a Fingerprint 2 authentication code output from the Fingerprint 2 module (U3) in the integrated module (U1) to output a corresponding authentication code via USB when the Fingerprint 1 matches Fingerprint 2 authentication code.

In the Fingerprint 1 module (U2), a GND line 1 is a (−) voltage circuit, an RX line 2 is a serial data reception port, a TX line 3 is a serial data transmission port, and a VCC line 4 is a (+) voltage reference of the power supply circuit and, by using the GND line 1, the RX line 2, the TX line 3, and the VCC line 4, a fingerprint is scanned in the image sensor and the scanned fingerprint image is compared with a previously-stored image, and when there is a person having a fingerprint which is identical to the previously-stored image, a registered authentication code of the person is output as an RS232 communication signal, in the Fingerprint 2 module (U3), a GND line 1 is a reference of the (−) voltage circuit, an RX line 2 is a serial data reception port, a TX line 3 is a serial data transmission port, and a VCC line 4 is a (+) voltage reference of the power supply circuit and, by using the GND line 1, the RX line 2, the TX line 3, and the VCC line 4, in the above configuration, a fingerprint is scanned in the image sensor and the scanned fingerprint image is compared with a previously-stored image, and when there is a person having a fingerprint which is identical to the previously-stored image, a registered authentication code of the person is output as an RS232 communication signal, in the integrated module (U1), a D1/TX line 1 is an RS232 serial communication transmission port, a DO/RX line 2 is an RS232 serial communication reception port, a GND line 4 is a (−) voltage reference, a D2 line 5 is an RS232 serial communication transmission line of the Fingerprint 1 module (U2), a D3 line 6 is an RS232 serial communication reception line of the Fingerprint 1 module (U2), a D9 line 12 is an RS232 serial communication transmission line of the Fingerprint 2 module (U3), a D10 line 13 is an RS232 serial communication reception line of the Fingerprint 2 module (U3), a 5V line 27 is a PIN for outputting a voltage of +5 V, a GND line 29 is a (−) voltage reference, and a VIN line 30 is a (+) voltage reference and, by using the D1/TX line 1, the DO/RX line 2, the GND line 4, the D2 line 5, the D3 line 6, the D9 line 12, the D10 line 13, the 5V line 27, the GND line 29, and the VIN line 30, a Fingerprint 1 authentication code output from the Fingerprint 1 module (U2) and a Fingerprint 2 authentication code output from the Fingerprint 2 module (U3) are received in the integrated module (U1), and when an authentication code of the Fingerprint 1 (U2) and an authentication code of the Fingerprint 2 (U3) match, the corresponding authentication codes are output via USB.

Still another aspect of embodiments of the present invention provides an input and output integrated module for simultaneously linking biometric information algorithms, which includes an integrated module (U1) for simultaneously authenticating Finger vein 1 and Finger vein 2 including a Finger vein 1 module (U2) and a Finger vein 2 module (U3), wherein: the Finger vein 1 module (U2) scans a finger vein in an image sensor, compares the scanned image with a previously-stored image, and outputs a registered authentication code of a corresponding person is output as a specific serial communication signal when there is a person having a finger vein which is identical to the previously-stored image; and the Finger vein 2 module (U3) scans a finger vein in an image sensor, compares the scanned image with a previously-stored image to output a registered authentication code of a corresponding person as a specific serial communication signal when there is a person having a finger vein which is identical to the previously-stored image, and receives a Finger vein 1 authentication code output form the Finger vein 1 module (U2) and a Finger vein 2 authentication code output from the Finger vein 2 module (U3) in the integrated module (U1) to output a corresponding authentication code via USB when an authentication code of the Finger vein 1 matches an authentication code of the Finger vein 2.

In the Finger vein 1 module (U2), a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in a conversion module (U4), a GND line 1 at a left side is a (−) voltage reference, an A line 2 is a serial communication standard RS485 communication A port, a B line 3 is a serial communication standard RS485 communication B port, a VCC line 4 is a (+) voltage reference, a DI line 5 at a right side of the conversion module (U4) which is linked with the Finger vein 1 module (U2) is an RS232 serial communication reception port, an RE line 6 is an RS485 communication control port, a DE line 7 is an RS485 communication control port, and an RO line 8 is an RS232 serial communication transmission port, which is linked with the integrated module (U1), in the Finger vein 2 module (U3), a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in a conversion module (U5), a GND line 1 at a left side which is linked with the Finger vein 2 module (U3) is a (−) voltage reference, an A line 2 is a serial communication standard RS485 communication A port, a B line 3 is a serial communication standard RS485 communication B port, a VCC line 4 is a (+) voltage reference, a DI line 5 at a right side of the conversion module (U5) is an RS232 serial communication reception port, an RE line 6 is an RS485 communication control port, a DE line 7 is an RS485 communication control port, and an RO line 8 is an RS232 serial communication transmission port, which is linked with the integrated module (U1), a Finger vein 1 authentication code output from the Finger vein 1 module (U2) and a Finger vein 2 authentication code output from the Finger vein 2 module (U3) are received in the integrated module (U1), and when an authentication code of the Finger vein 1 matches an authentication code of the Finger vein 2, the corresponding authentication codes are output via USB.

According to embodiments of the present invention, a false acceptance rate of finger veins can be significantly improved, a false acceptance rate of fingerprints can be decreased by simultaneously authenticating fingerprints and finger veins, errors in determining similarities between blood vessels of finger veins can be decreased, and human body information of a person can be easily recognized even by using only one finger. Therefore, high security capable of replacing an accredited certificate can be achieved.

Therefore, even when two fingers are used, an error range related to a fingerprint recognition rate or a finger vein recognition rate is decreased by reducing recognition rates of fingerprints and finger veins when a combination of fingerprints and finger veins are used to determine whether a user is authenticated. In this way, an authentication determination speed can be increased, manufacture of authentication determination equipment can be facilitated, and an error range can be significantly decreased.

Further, embodiments of the present invention can be realized by developing an integrated module for simultaneously authenticating fingerprints and finger veins.

When the above-described advantages and weaknesses are complemented, and biometric information is acquired through a polyhedral stereoscopic authentication device that uses a technology in which finger vein authentication and fingerprint authentication are combined and simultaneously scans fingerprints and finger veins of two fingers, uniqueness of one's biometric information is expected to be maintained until the end of the world.

In a fingerprint and finger vein imaging and authentication device, a fingerprint acquisition module is provided at the front ⅓ portion of an upper end portion at which a finger is authenticated, and a finger vein acquisition module is provided from a first finger joint behind the front ⅓ portion to an inner portion of a second finger joint. After fingerprint and finger vein information of a user is acquired, the acquired information is formed into a database. At the moment at which an index finger and a middle finger or a middle finger and a ring finger, which form a double “1” shape or form a V-shape together due to partition portions formed according to interference of infrared light transmitted from below, are naturally brought into contact with a terminal, the fingers are simultaneously authenticated using a polyhedral stereoscopic imaging technique. In this way, all functions of the fingerprint and finger vein imaging and authentication device are secured.

When two fingers are used as described above, since a contact angle is constant and congruity and stability of authentication portions that come into contact with the two fingers are ensured, fingerprints or finger veins can be recognized with high accuracy.

Particularly, as it is confirmed in a Google search result or a search result provided by Doopedia when “fingerprint authentication technology” is searched on Naver, the probability that one has the same fingerprint as someone else is only one in one billion.

Despite the low probability, forgery and falsification problems have not been completely solved. However, in embodiments of the present invention, by operating a temperature sensor, which uses pulsation of bloodstream, at the moment at which two parallel fingers as well as fingerprints and finger veins thereof naturally come into contact with a terminal, and the temperature sensor being used in conjunction with the technology of the polyhedral stereoscopic imaging device, all of the fingerprints and finger veins, which are classified into four different forms, of the two fingers are simultaneously scanned and recognized. In this way, all false acceptance and false rejection problems are eliminated.

### BRIEF DESCRIPTION

Some of the embodiments will be described in detail, with reference to the following figures, wherein like designations denote like members, wherein:

FIG. 1 is a view conceptually showing a finger vein and fingerprint image acquisition mechanism of an authentication device (100);

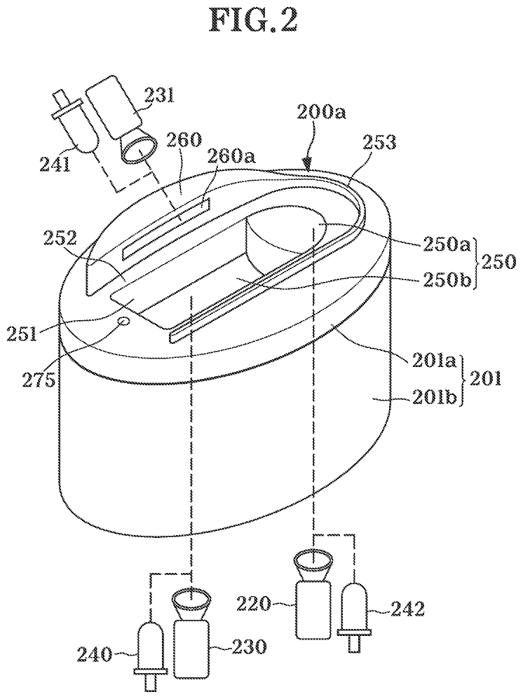

FIG. 2 is a view conceptually showing a finger vein and fingerprint image acquisition mechanism of an authentication device (200), including an embodiment of a mounting portion at an upper portion on which a finger is placed;

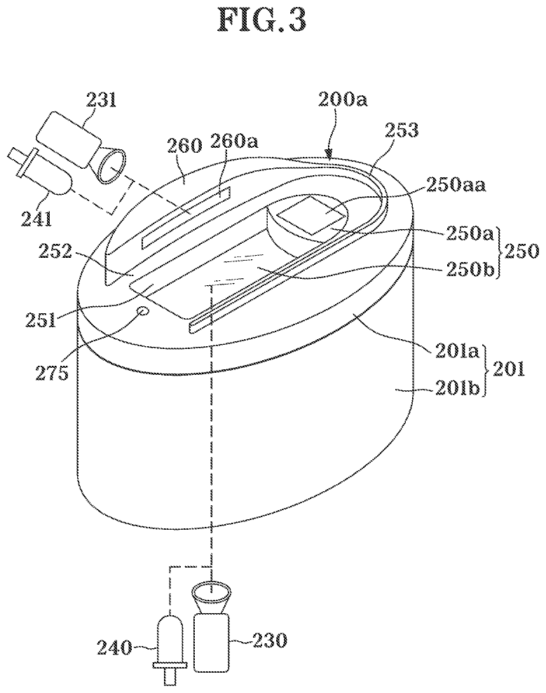

FIG. 3 is a view conceptually showing a finger vein and fingerprint image acquisition mechanism of an authentication device (200), including another embodiment of a mounting portion at an upper portion on which a finger is placed;

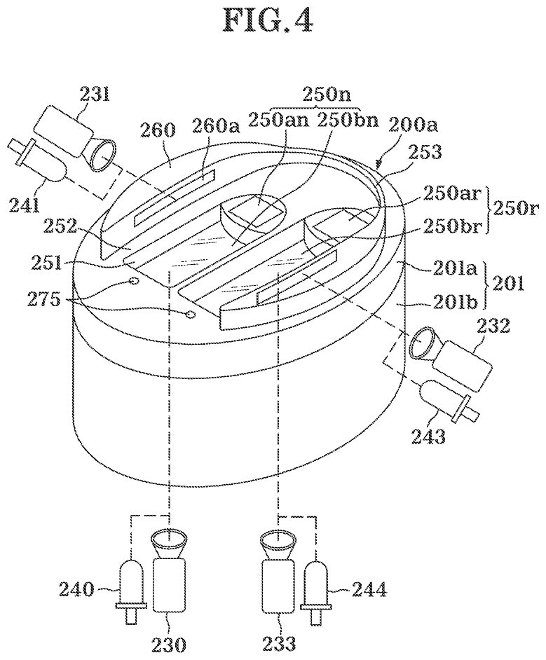

FIG. 4 is a view conceptually showing a mechanism of acquiring fingerprint and finger vein images of two fingers put on the authentication device (200);

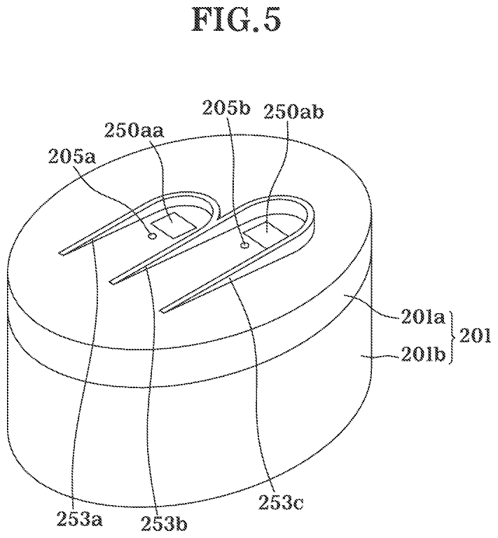

FIG. 5 is a view conceptually showing a mechanism of acquiring fingerprint images of two fingers put on the authentication device (200);

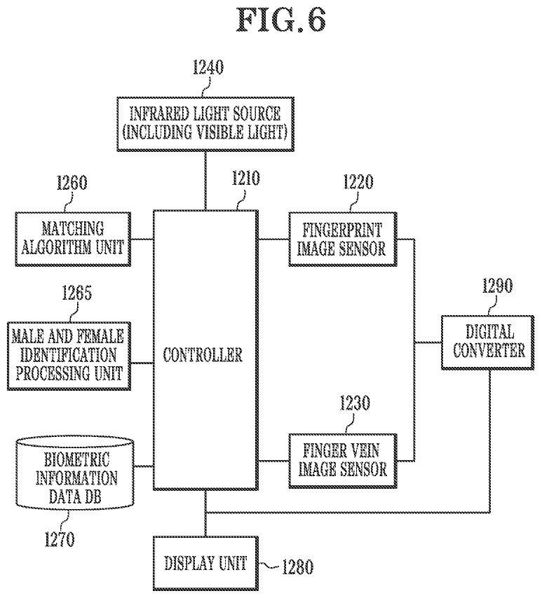

FIG. 6 is a diagram showing an internal electronic configuration example of the authentication device (200);

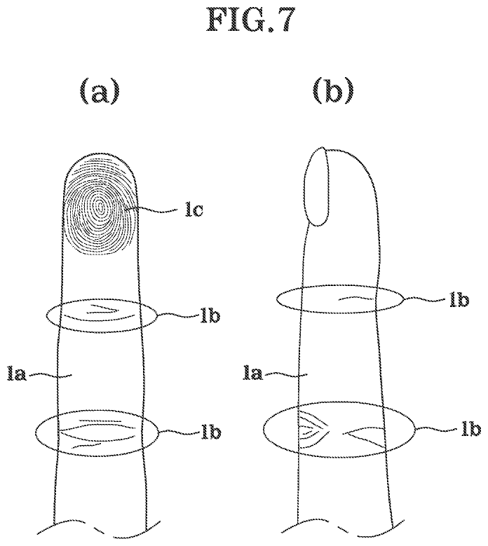

FIG. 7A shows a fingerprint surface of the same finger whose images are captured by a fingerprint image sensor and a finger vein image sensor;

FIG. 7B shows a side of a fingerprint surface of the same finger as FIG. 7A whose images are captured by a fingerprint image sensor and a finger vein image sensor;

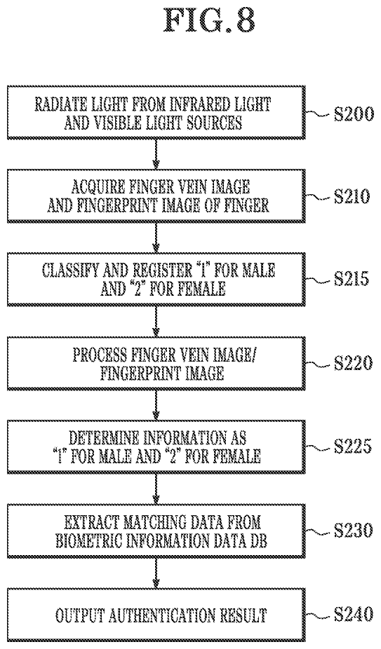

FIG. 8 is a diagram showing a configuration example of all processes of an authentication method using an authentication device;

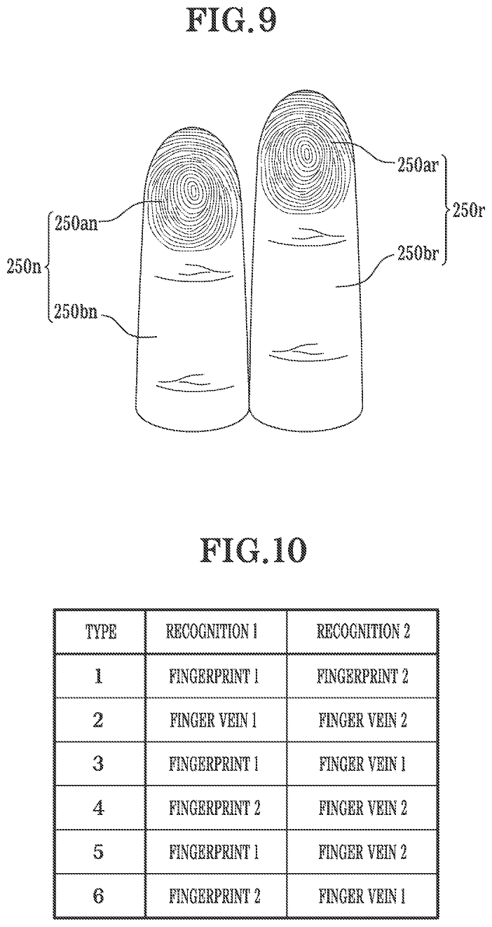

FIG. 9 is a view in which fingerprint and finger vein images of two fingers are shown by being distinguished from each other;

FIG. 10 is a matrix table showing possible combination pairs of Fingerprint 1, Fingerprint 2, Finger vein 1, and Finger vein 2;

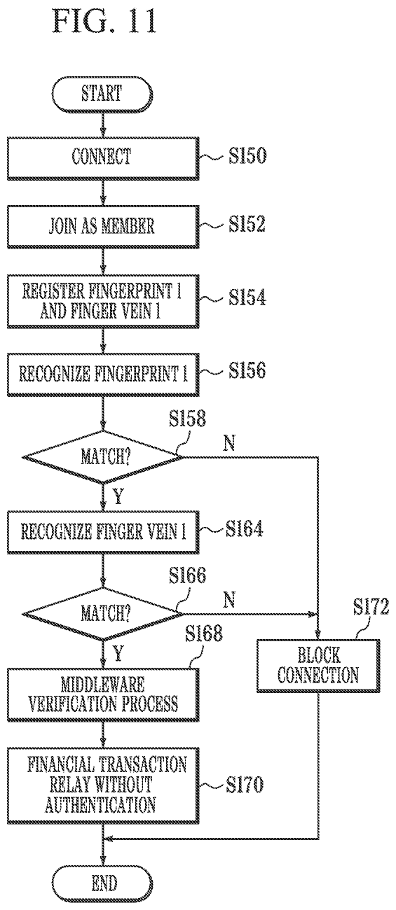

FIG. 11 is a flowchart of a case in which Fingerprint 1 and Finger vein 1 are recognized simultaneously;

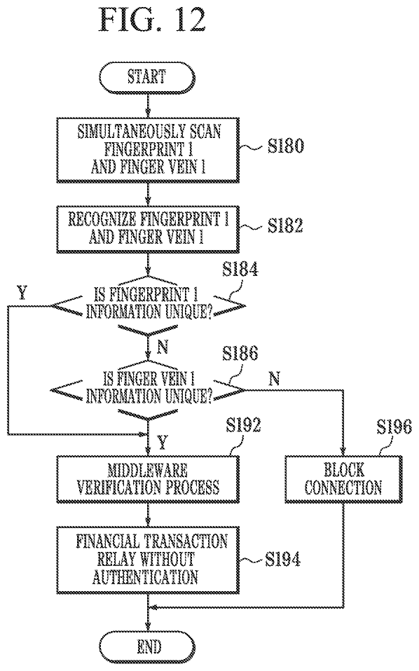

FIG. 12 is a flowchart of a case in which Fingerprint 1 and Finger vein 1 are recognized simultaneously;

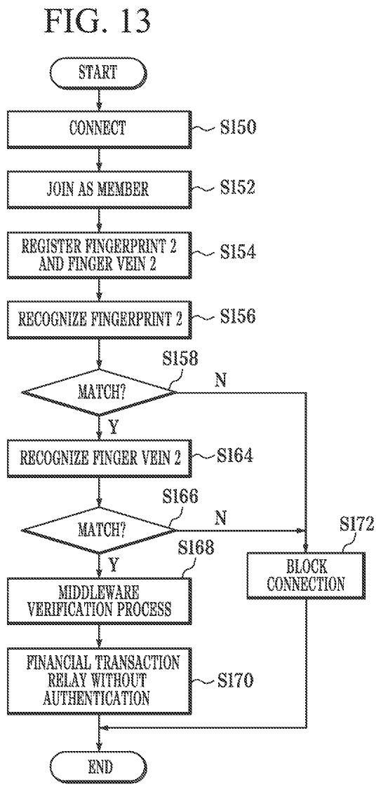

FIG. 13 is a flowchart of a case in which Fingerprint 2 and Finger vein 2 are recognized simultaneously;

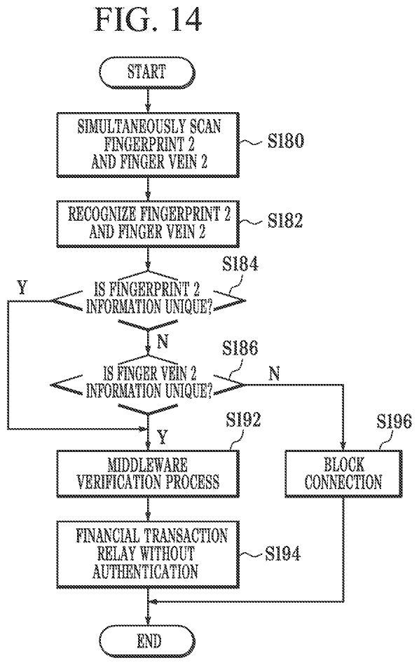

FIG. 14 is a flowchart of a case in which Fingerprint 2 and Finger vein 2 are recognized simultaneously;

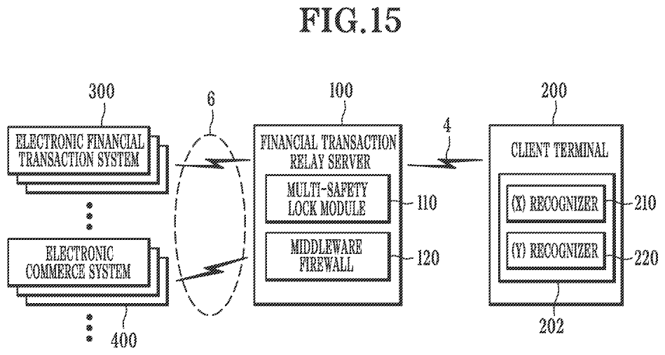

FIG. 15 is a block diagram showing a financial transaction system;

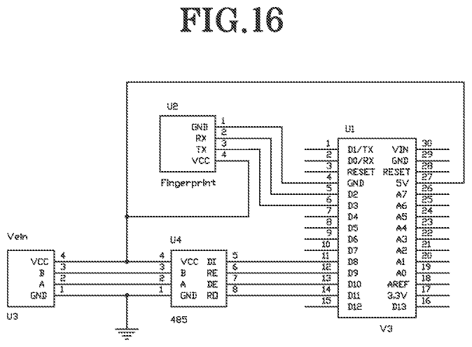

FIG. 16 is a diagram showing an input and output integrated module for linking fingerprint and finger vein algorithms;

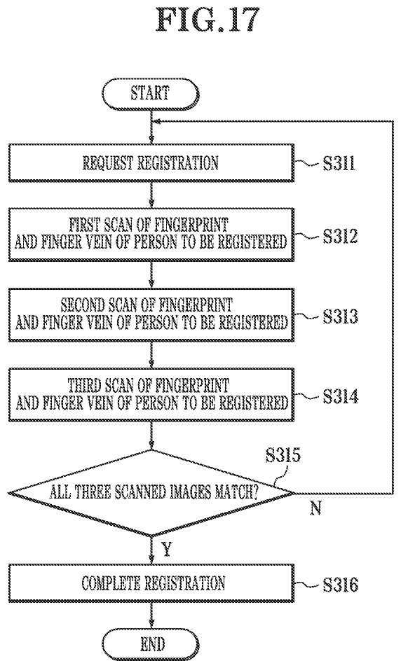

FIG. 17 is a flowchart showing a process of requesting fingerprint and finger vein registration;

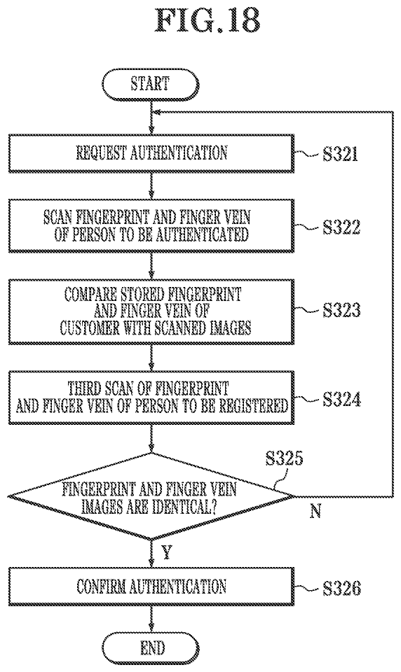

FIG. 18 is a flowchart showing a process of requesting fingerprint and finger vein authentication;

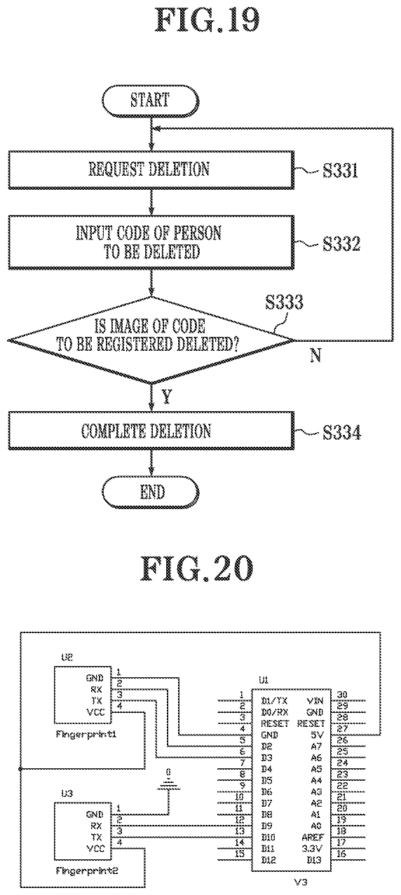

FIG. 19 is a flowchart showing a process of requesting fingerprint and finger vein deletion;

FIG. 20 is a diagram showing an input and output integrated module for linking fingerprint and finger vein algorithms; and

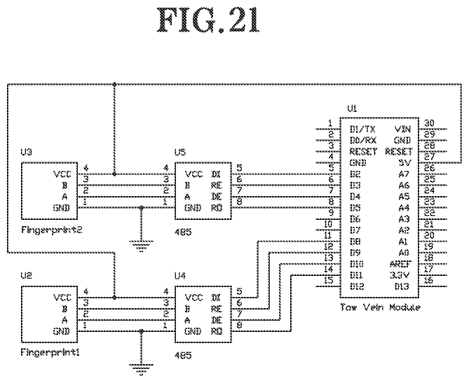

FIG. 21 is a diagram showing an input and output integrated module for linking algorithms of Finger vein 1 and Finger vein 2.

### LIST OF REFERENCES

200: integrated imaging and authentication device
201: object accommodating portion
201a: scan panel upper case
201b: scan panel lower case
220, 230, 231: image sensor
240, 241: infrared light source
242: visible light source
250: scan panel
250a: fingerprint finger contact portion
250b: fingerprint finger non-contact portion
260a: infrared light side transmitter
260: infrared light side transmitter case

### DETAILED DESCRIPTION

In describing embodiments of the present invention, when detailed description of a related known function that is self-evident to those of ordinary skill in the art is determined as having the possibility of unnecessarily blurring the gist of embodiments of the present invention, the detailed descriptions thereof will be omitted.

FIG. 1 is a view conceptually showing a finger vein and a finger-joint fingerprint image acquisition mechanism of an authentication device 100 according to an exemplary embodiment of the related art. FIGS. 2 and 3 are views conceptually showing a finger vein and a finger-joint fingerprint image acquisition mechanism of an authentication device 200 according to embodiments of the present invention, each of which are different embodiments of a mounting portion at an upper portion on which a finger is placed. FIG. 4 is a view conceptually showing a mechanism of acquiring fingerprint and finger vein images of two fingers put on the authentication device 200 according to embodiments of the present invention. FIG. 5 is a view conceptually showing a mechanism of acquiring fingerprint images of two fingers put on the authentication device 200 according to embodiments of the present invention. FIG. 6 is a diagram showing an internal electronic configuration example of the authentication device 200 of embodiments of the present invention. FIG. 7 shows a fingerprint surface (see FIG. 7A) and a side (see FIG. 7B) of the same finger whose images are captured by a fingerprint image sensor and a finger vein image sensor. FIG. 8 is a diagram showing a configuration example of all processes of an authentication method using an authentication device of embodiments of the present invention.

As shown in FIG. 2, embodiments of the present invention are related to an integrated imaging and authentication device 200 capable of capturing images of fingerprints and finger veins. The integrated imaging and authentication device 200 includes an object accommodating portion 201 that includes a scan panel upper case 201a, which forms a finger mounting portion, formed at an upper portion and including a scan panel lower case 201b, which accommodates a full-length portion of the scan panel upper case 201a and is formed at a lower portion and a scan panel 250, which is made of a transparent material such as glass or acryl and is provided at an upper portion of the scan panel upper case 201a and configured to simultaneously capture images of fingerprints and finger veins. In the scan panel 250, a fingerprint finger contact portion 250a and a finger vein finger non-contact portion 250b may be formed at a front portion and a rear portion, respectively, with a height difference.

A groove sidewall 251 is formed at an edge of the finger vein finger non-contact portion 250b of the scan panel 250 so that the finger vein finger non-contact portion 250b is formed as a groove, and a finger mounting portion 252 is formed to be parallel with the fingerprint finger contact portion 250a so that a finger may be placed around an upper end of the finger vein finger non-contact portion 250b.

In addition, a temperature sensor 275 configured to detect a bloodstream temperature of a finger is formed in front of the finger vein finger non-contact portion 250b to face the fingerprint finger contact portion 250a of the scan panel 250. In this way, when a finger is brought into contact with the temperature sensor 275, a temperature and bloodstream of the finger may be detected, and finger veins may be recognized by the detected temperature and bloodstream.

In addition, in order to capture more accurate finger vein images, an infrared light side transmitter case 260 configured to accommodate an infrared light side transmitter 260a is longitudinally formed at one side so that images of finger veins may be captured from the side.

The scan panel lower case 201b is formed to have a space in which electrical components may be accommodated.

In addition, a finger mounting boundary 253, within which a finger may be mounted, is formed.

Therefore, in embodiments of the present invention, a user places a finger object on the scan panel 250 to start finger vein authentication. Upon start of finger vein authentication by the device, an infrared light source 240 and a visible light source 242 irradiate the finger object with infrared light and visible light.

Then, a plurality of visible light image sensors capture images of fingerprints and finger veins of the finger which have been irradiated with the infrared light and the visible light.

In the first embodiment of the present invention, two image sensors 220 and 230 are embedded in the integrated imaging and authentication device 200. A finger vein image sensor 230 is provided to be embedded in the object accommodating portion 201 and captures an image of finger veins of the object facing the scan panel 250 from below the scan panel 250. In addition, almost simultaneously, a fingerprint image sensor 220, which is provided in the same object accommodating portion 201, captures an image of a fingerprint of the object.

In a second embodiment of the present invention, a user places a finger object on the scan panel 250 to start finger vein authentication. Upon start of finger vein authentication by the device, infrared light sources 240 and 241 and a visible light source 242 irradiate the finger object with infrared light and visible light.

The image sensors thereof capture images of fingerprints and finger veins of the finger which have been irradiated with the infrared light and the visible light.

In the second embodiment of the present invention, three image sensors 220, 230, and 231 are embedded in the integrated imaging and authentication device 200. Finger vein image sensors 230 and 231 are provided to be embedded in the object accommodating portion 201 and capture images of finger veins of the object toward the scan panel 250 from below the scan panel 250. In addition, almost simultaneously, a fingerprint image sensor 220, which is provided in the same object accommodating portion 201, captures an image of a fingerprint of the object.

In embodiments of the present invention, the finger vein image sensors 230 and 231 and the fingerprint image sensor 220 simultaneously capture images of finger veins and fingerprints of the finger, and both images are used as biometric information. In this way, an error range may be reduced to, at maximum, one over a square of a certain value as compared to when a fingerprint image and a finger vein image are separately captured to measure a fingerprint or finger veins.

In embodiments of the present invention, the finger vein image sensors 230 and 231 and the fingerprint image sensor 220 may capture a finger vein image and a fingerprint image of a single finger at once. Here, the finger vein image is captured from a side that is 90° from a fingerprint surface so that a fingerprint image and a finger vein image are simultaneously acquired from a single finger, thereby obtaining the above-described effect of reducing the error range. When capturing an image of a side of a finger, the finger is rotated toward the side that is 90° from the fingerprint surface while the finger is placed on the scan panel so that the side of the finger is in contact with the scan panel.

FIG. 3 is a third embodiment of the present invention. The third embodiment is mostly the same as the embodiment shown in FIG. 2. However, in a fingerprint recognizing portion, while the three image sensors 220, 230, and 231 are embedded in the integrated imaging and authentication device 200 in the second embodiment, a fingerprint recognition module 250aa is formed instead of the fingerprint image sensor 220 and a method capable of determining a fingerprint by coming into contact with the fingerprint is provided in the third embodiment.

The fingerprint recognition module 250aa is formed as a multi-layer thin plate structure. A fingerprint recognition layer is formed at an upper layer portion of the fingerprint recognition module, and a temperature and bloodstream sensing authentication layer is formed below the fingerprint recognition layer so that operation of the fingerprint recognition module 250aa may be formed to start after a temperature and bloodstream of the human body are detected.

FIG. 4 is a fourth embodiment of the present invention in which fingerprints and finger veins of two fingers are used. The same reference numerals and technical terms will be used for technical configurations which are the same as those of the embodiment shown in FIG. 2.

As shown in FIG. 4, embodiments of the present invention are an integrated imaging and authentication device 200 capable of capturing images of fingerprints and finger veins. The integrated imaging and authentication device 200 includes a scan panel upper case 201a, which forms a finger mounting portion and is formed at an upper portion and including a scan panel lower case 201b, which accommodates a full-length portion of the scan panel upper case 201a and is formed at a lower portion and two scan panels 250n and 250r, which are formed of a transparent material such as glass or acryl, provided at an upper portion of the scan panel upper case 201a and configured to simultaneously capture images of fingerprints and finger veins of two fingers. In the two scan panels 250n and 250r, fingerprint finger contact portions 250an and 250ar and finger vein finger non-contact portions 250bn and 250br are formed at front portions and rear portions, respectively, with a height difference.

A groove sidewall 251 is formed at an edge of the finger vein finger non-contact portion 250bn of any one scan panel 250n so that the finger vein finger non-contact portion 250bn is formed as a groove, and a finger mounting portion 252 is formed to be parallel with the fingerprint finger contact portion 250a so that a finger is placed around an upper end of the finger vein finger non-contact portion 250bn.

In addition, temperature sensors 275 configured to detect a bloodstream or temperature of a finger are formed in front of the finger vein finger non-contact portion 250bn to face the fingerprint finger contact portion 250an of the scan panel 250. In this way, when a finger is brought into contact with the temperature sensor 275, a temperature or bloodstream of the finger may be detected, and finger veins may be recognized by the detected temperature or bloodstream.

Further, temperature sensors 205a and 205b configured to detect a bloodstream or temperature of a finger may be formed at lower portions of the fingerprint recognition modules 250aa and 250ab of the scan panels, or a thin plate layer configured to authenticate a bloodstream or temperature of the finger may be formed at any one layer of the fingerprint recognition modules 250aa and 250ab. In this way, operation of the fingerprint recognition modules 250aa and 250ab may not be allowed when the two fingers are not simultaneously authenticated.

That is, the fingerprint finger contact portions 250an and 250ar may be formed instead of the temperature sensor 275. The fingerprint finger contact portions 250an and 250ar may be formed as multi-layer thin plate structures. A fingerprint recognition layer is formed at upper layer portions of the fingerprint recognition modules and a temperature and bloodstream sensing authentication layer is formed below the fingerprint recognition layer so that operation of the fingerprint finger contact portions 250an and 250ar may be formed to start after a temperature and bloodstream of the human body are detected.

In addition, in order to capture more accurate finger vein images, an infrared light side transmitter case 260 configured to accommodate an infrared light side transmitter 260a is longitudinally formed at one side so that images of finger veins may be captured from the side.

In addition, a user places a finger object on the scan panels 250n and 250r to start finger vein authentication. Upon start of finger vein authentication by the device, infrared light sources 241 and 243 irradiate the finger objects with infrared light from the left side and the right side, respectively, and infrared light sources 240 and 244 irradiate the finger objects with infrared light from the lower side.

Then, left and right image sensors 231 and 232 and lower image sensors 230 and 233 thereof capture finger vein images of the fingers that have been irradiated with the infrared light and the visible light.

The scan panel lower case 201b is formed to have a space in which electrical components may be accommodated.

In addition, a finger mounting boundary 253, within which a finger may be placed, is formed.

Therefore, in the fourth embodiment of the present invention, a user places a finger object on the scan panels 250n and 250r to start fingerprint and the finger vein authentication. Upon start of the fingerprint and finger vein authentication by the device, the infrared light sources 240 and 244 irradiate the finger objects with infrared light.

To ensure accuracy, the finger objects are irradiated with infrared light by the infrared light sources 241 and 243 formed at the left and right sides, respectively.

In addition, almost simultaneously, the fingerprint authentication modules 250an and 250ar, which are provided in the same object accommodating portion 201, authenticate fingerprints of the objects.

Here, the imaging device represented by a polyhedral stereoscopic imaging device has been described. The imaging device may be explained as a six-dimensional (6D) imaging device having two lower portions and two side portions with respect to a finger vein, and two portions with respect to a fingerprint, as surfaces of imaging status.

In embodiments of the present invention, images of finger veins and fingerprints of the fingers are simultaneously captured, and both images are used as biometric information. In this way, an error range may be reduced to, at maximum, one over a square of a certain value as compared to when a fingerprint image and a finger vein image are separately captured to measure a fingerprint or finger veins.

FIG. 5 is a fifth embodiment of the present invention in which fingerprints of two fingers are used. The same reference numerals and technical terms will be used for technical configurations which are the same as those of the embodiments illustrated in FIGS. 2 and 4.

As shown in the drawing, the fifth embodiment is mostly the same as the embodiments illustrated in FIGS. 2 and 4. However, in the fifth embodiment, fingerprint recognition modules 250aa and 250ab are formed instead of the fingerprint image sensor 220 in other embodiments so that two fingerprints may be simultaneously authenticated only using a fingerprint recognition portion, and a method, which is capable of determining fingerprints by coming into contact with the fingerprints, is provided.

Even in this case, to increase a security rate, the above-described temperature sensors 205a and 205b configured to detect a bloodstream temperature of fingers may be formed in front of the fingerprint recognition modules 250aa and 250ab. In this way, when fingers are brought into contact with the temperature sensors 205a and 205b, temperatures and bloodstreams of the fingers may be detected, and finger veins may be recognized by the detected temperatures and bloodstreams.

Fingerprint recognition modules 250aa and 250ab may be formed instead of the temperature sensors 205a and 205b. The fingerprint recognition modules 250aa and 250ab may be formed as multi-layer thin plate structures. A fingerprint recognition layer is formed at upper layer portions of the fingerprint recognition modules and a temperature and bloodstream sensing authentication layer is formed below the fingerprint recognition layer so that operation of the fingerprint recognition modules 250aa and 250ab may be formed to start after a temperature and bloodstream of the human body are detected.

FIG. 6 is an internal electronic configuration example of a finger vein imaging and authentication device 200 according to embodiments of the present invention.

An integrated imaging and authentication device 200 include an infrared light source 1240, a finger vein image sensor 1230, a fingerprint image sensor 1220, a digital converter 1290, a decryption algorithm unit 1260, a male and female identification processing unit 1265, a biometric information data storage unit 1270, and a display unit 1280.

Although not shown in the drawing, the integrated imaging and authentication device 200 may further include a power supply, a communication unit, and various input/output (I/O) devices.

The infrared light source 240 emits infrared light toward an object accommodating portion. The infrared light source 240 may include one or more light-emitting diodes (LEDs) and may emit infrared light having a wavelength of 630 to 1,000 nm that is suitable for capturing a finger vein image. In addition, an optical filter may be provided in the infrared light source 240 to filter optical noise.

A visible light source 242 emits visible light toward the object accommodating portion. The visible light source 242 may include one or more LEDs and emit ultraviolet light having a wavelength suitable for capturing an image of fingerprints on a surface of a finger.

In addition, in embodiments of the present invention, a single infrared light source 240 configured to radiate infrared light toward an object accommodating portion and a single visible light source 242 configured to radiate visible light toward the object accommodating portion may be provided.

In other embodiments of the present invention, a plurality of infrared light sources 240 and a plurality of visible light sources 242 may be provided in an object accommodating portion 101 so that infrared light and visible light evenly reach an object, thereby optimizing image acquisition.

In embodiments of the present invention, finger vein image sensors 230 and 231 acquire a finger vein image of a single finger object from below and beside the finger object.

In other embodiments of the present invention, a finger vein image sensor 230 acquires a fingerprint image and a side finger vein image of a single finger object.

FIGS. 7A and 7B show angles at which infrared imaging is performed on an inner surface and a side of a single finger.

The reference numeral 1a, which has not been described above, indicates a finger vein portion between finger joints, the reference numeral 1b indicates a finger joint, and the reference numeral 1c indicates a fingerprint portion.

When capturing a front image of a finger object, the image is captured while the finger is placed such that a fingerprint surface of the finger comes into contact with a scan panel, and according to the number of finger vein image sensors 230, 231,232, and 233, the finger is rotated sideways by 90° so that a side of the finger is comes into contact with the scan panel. An order of imaging the fingerprint surface and the side of the finger may be reversed.

The digital converter 290 receives both of the finger vein image and the fingerprint image and extracts the images as finger vein and fingerprint images. The embodiments obtain finger vein and fingerprint image files of a finger by the digital converter 290.

A controller 210 allows the image files converted in the digital converter 290 to be transmitted to a matching algorithm unit 260.

When simultaneously authenticating the fingerprint and the finger vein, the male and female identification processing unit 265 functions to classify and register male information and female information into “1” and “2,” respectively.

Previously-stored biometric information of a user is stored in the biometric information data storage unit 270. In embodiments of the present invention, the biometric information data storage unit 270 may be constructed in an internal memory of the authentication device 200.

In other embodiments of the present invention, the data storage unit 270 may be disposed in a storage unit outside the device and may be accessed via wired or wireless communication.

A crypto-processor, which may be protected from hardware and software attacks or theft from the outside, may be used as the biometric information data storage unit 270.

The matching algorithm unit 260 acquires user data stored in the biometric information data storage unit 270 and then determines whether the acquired user data matches a user biometric information value acquired by the digital converter 290. When it is determined that the user data matches the user biometric information value, a success message may be output on the display unit 280. When decoding has failed, an authentication failure message may be output on the display unit 280.

The controller 210 controls operations and functions of the authentication device 200.

In particular, the controller 210 determines finger vein image acquisition, processing, authentication computation, and an authentication result. Various pieces of software may be used in relation to processing and computation of an acquired finger vein image.

For example, a Canny edge detector algorithms may be used. The image may be applied to fully filter noise from an original image. The image is formed into an image that consists of edges through an image gradient. That is, sketch lines of the image are extracted. A task of decreasing thicknesses of the edges (sketch lines) is performed by applying non-maximum suppression, and bold edges are classified as definite edges while faded edges are assumed to be noise and classified as weak edges by applying a double threshold. Then, lastly, the weak edges are deleted and only the definite edges are kept so as to finally output a finger vein image which consists of edges.

An embodiment of an authentication process of an authentication device of embodiments of the present invention will be re-summarized on the basis of the above detailed description. The process is shown in FIG. 8.

First, an authentication target places his or her finger on an object accommodating portion of an authentication device which is in a standby state. In this case, an authentication method is a method in which images of a fingerprint surface and finger veins of a single finger are captured from below and/or beside the finger.

In the case of the embodiment in which authentication is performed using only one finger, infrared and visible light imaging of a fingerprint surface and a side of a single finger (S200) and imaging of finger veins and fingerprints (S210) are repeated a total of two to three times.

That is, after operations S200 and S210 are performed on a fingerprint surface of a single finger, operations S200 and S210 are performed on a side of the same finger. The finger vein and fingerprint images which have been captured in this way are converted into digital images.

In operation S215, when simultaneously authenticating the fingerprint and the finger vein, the male and female identification processing unit 265 classifies and registers the male and female information into “1” for male and “2” for female.

When the customer information is registered by a customer client or a franchisee client and then the process proceeds to a procedure of determining the customer information, a false acceptance rate of embodiments of the present invention may be decreased by half

The customer information includes member information of the customer, such as name, gender, a contact such as an authenticated cell phone number, password, e-mail address, and the like, which are input when the customer client activates a fingerprint and/or finger vein payment application 202 to register the customer as a member.

Next, a controller extracts the captured fingerprint and finger vein images (S220). Here, as shown in FIGS. 7A and 7B, a fingerprint extracted from a fingerprint image and a portion between two finger joint wrinkles may be used as image extraction regions, and the image extraction regions may be processed into a finger vein image, which consists of edges, using the above-described Canny edge detector algorithm.

Then, in operation S225, the male and female customer information registered in the male and female identification processing unit 265 is classified into “1” for male and “2” for female to determine the information.

Then, the user's biometric data stored in a biometric information data storage unit is compared with fingerprint and finger vein images of a finger that have “just” been acquired and processed. When the biometric data and the images match each other, it is determined as a success of fingerprint and finger vein authentication, and when the biometric data and the images fail to match each other, it is determined as an authentication failure.

An authentication result is displayed on a display. The result may also be displayed with a sound.

Next, a method of capturing images of two fingers will be described.

First, an authentication target places his or her finger on an object accommodating portion of an authentication device which is in a standby state. In this case, an authentication method is a method in which images of fingerprint surfaces and finger veins of two fingers are captured from below and/or beside the fingers.

In the case of the embodiment in which authentication is performed using two fingers, infrared imaging of a fingerprint surface and a lower portion or side of two fingers (S200) and imaging of finger veins and fingerprints (S210) are repeated a total of two to three times.

That is, after operations S200 and S210 are performed on fingerprint surfaces of two fingers, operations S200 and S210 are performed on a side of the same finger. The finger vein and fingerprint images which have been captured in this way are converted into digital images.

Here, any one of the lower portion and the side may be omitted depending on the design.

Next, a controller extracts the captured fingerprint and finger vein images (S220). Here, as shown in FIGS. 7A and 7B, a fingerprint extracted from a fingerprint image and a portion between two finger joint wrinkles may be used as image extraction regions, and the image extraction regions may be processed into a finger vein image, which consists of edges, using the above-described Canny edge detector algorithm.

Then, the user's biometric data stored in a biometric information data storage unit is compared with fingerprint and finger vein images of fingers that have “just” been acquired and processed. When the biometric data and the images match each other, it is determined as a success of fingerprint and finger vein authentication, and when the biometric data and the images fail to match each other, it is determined as an authentication failure.

An authentication result is displayed on a display. The result may also be displayed with a sound.

An authentication device of embodiments of the present invention performs authentication by simultaneously utilizing, for example, fingerprint images and finger vein data of fingers, thereby significantly reducing a false acceptance rate.

Next, a method of utilizing images of recognized fingerprints and finger veins will be described.

FIG. 9 is a view in which fingerprint and finger vein images of two fingers are shown by being distinguished from each other according to embodiments of the present invention. FIG. 10 is a matrix table showing possible combination pairs of Fingerprint 1, Fingerprint 2, Finger vein 1, and Finger vein 2 according to embodiments of the present invention.

Here, there are six cases in which the number of fingerprint and finger vein images may be at least more than one.

That is, the six cases include: 1) Fingerprint 1 (250an) and Fingerprint 2 (250ar); 2) Finger vein 1 (250bn) and Finger vein 2 (250br); 3) Fingerprint 1 (250an) and Finger vein 1 (250bn); 4) Fingerprint 2 (250ar) and Finger vein 2 (250br); 5) Fingerprint 1 (250an) and Finger vein 2 (250br); and 6) Fingerprint 2 (250ar) and Finger vein 1 (250bn). Although the fingerprints and finger veins may be combined in other more complicated forms, it is possible to account for the whole population of the world just with combination pairs.

Next, a method will be described in which whether a user is authenticated is determined from a fingerprint and finger vein combination and a financial transaction is relayed without authentication through middleware verification.

FIGS. 11 and 12 are flowcharts of a case in which Fingerprint 1 and Finger vein 1 according to embodiments of the present invention are recognized simultaneously. FIGS. 13 and 14 are flowcharts of a case in which Fingerprint 2 and Finger vein 2 according to embodiments of the present invention are recognized simultaneously. FIG. 15 is a block diagram showing a financial transaction system of embodiments of the present invention.

FIG. 11 is a flowchart illustrating a different processing order of a financial transaction relay system having a multi-safety lock function using Fingerprint 1 authentication according to an embodiment of embodiments of the present invention.

Referring to FIG. 11, in a financial transaction relay system 2 of embodiments of the present invention, a client terminal 200 is connected to a financial transaction relay server 100 via a communication network 4 in operation S150 and joins the server as a member in operation S152. In this case, the client terminal 200 inputs personal information of the client such as a name, an identification (ID), a password, a phone number, and an e-mail address.

In operation S154, the client terminal 200 acquires Finger vein 1 information and Fingerprint 1 information via a Finger vein 1 recognizer 210 and a Fingerprint 1 recognizer 220, and when the Finger vein 1 information and the Fingerprint 1 information are transmitted to the financial transaction relay server 100 via the communication network 4, the financial transaction relay server 100 registers the Finger vein 1 information and the Fingerprint 1 information corresponding to the client terminal 200. In this case, the financial transaction relay server 100 stores the Finger vein 1 information and the Fingerprint 1 information in a database.

In operation S156, to perform an electronic financial transaction and an electronic commerce transaction, the financial transaction relay server 100 firstly recognizes Fingerprint 1. In operation S158, the financial transaction relay server 100 determines whether the Fingerprint 1 matches the Fingerprint 1 information stored in the database and authenticates a user of the client terminal 200.

As a result of the determination, when the two pieces of information match, the financial transaction relay server 100 secondly recognizes Finger vein 1 in operation S164 and determines whether the Finger vein 1 matches the Finger vein 1 information stored in the database in operation S166.

As a result of the determination, when the two pieces of Finger vein 1 information match, the process proceeds to operation S168 and, thirdly, firewall protection is released in a multi-safety lock module 110 through a middleware verification process unit 120 so that the database of the financial transaction relay server 100 may be accessed. Then, in operation S170, the financial transaction relay server 100 is connected to an electronic financial transaction system 300 or an electronic commerce system 400 without authentication and processes a financial transaction to be relayed.

However, when either one of Finger vein 1 information and Fingerprint 1 information does not match Finger vein 1 and Fingerprint 1 of the client terminal 200 in operation S158 and in operation S166, the process proceeds to operation S172, and connection of the financial transaction relay server 100 is blocked so that the financial transaction relay server 100 is not allowed to process an electronic financial transaction and an electronic commerce transaction.

This is because, in the case of Fingerprint 1 recognition, since authentication using Fingerprint 1 recognition is possible only when one is alive and thus may only be executed by the user himself or herself, the security effect is unchanged even without another additional password process.

FIG. 12 is a flowchart illustrating a different processing order of a financial transaction relay system having a multi-safety lock function in which user authentication is processed by simultaneously scanning Fingerprint 1 and Finger vein 1 according to embodiments of the present invention. This embodiment is performed when user identification is difficult due to Fingerprint 1 information and Finger vein 1 information being identical or similar to other pieces of fingerprint information. First user authentication is processed using Fingerprint 1 information, and when user identification in the first user authentication is difficult, Finger vein 1 information is used secondly to process user authentication.

That is, referring to FIG. 12, in a financial transaction relay system 2 of embodiments of the present invention, in operation S180, Finger vein 1 and Fingerprint 1 are simultaneously scanned by a Finger vein 1 recognizer 210 and a Fingerprint 1 recognizer 220 of a client terminal 200, and the Finger vein 1 information and the Fingerprint 1 information are provided to a financial transaction relay server 100.

In operation S182, the financial transaction relay server 100 recognizes the Fingerprint 1 information and the Finger vein 1 information. In operation S184, the financial transaction relay server 100 compares the Fingerprint 1 information with other pieces of Fingerprint 1 information stored in a database and determines whether the Fingerprint 1 information is unique.

As a result of the determination, when the Fingerprint 1 information is unique, the process proceeds to operation S186. When the Fingerprint 1 information is not unique, that is, when user identification is difficult due to the Fingerprint 1 information being identical or similar to other pieces of fingerprint information, the financial transaction relay server 100 compares the Finger vein 1 information with other pieces of Finger vein 1 information stored in a database and determines whether the Finger vein 1 information is unique in operation S186.

As a result of the determination, when the Finger vein 1 information is unique, the process proceeds to operation S192, and the financial transaction relay server 100 processes user authentication for releasing a firewall protection or blocking the connection.

In operation S192, firewall protection is released in a multi-safety lock module 110 through a middleware verification process unit 120 so that the database of the financial transaction relay server 100 may be accessed. Then, in operation S194, the financial transaction relay server 100 is connected to an electronic financial transaction system 300 or an electronic commerce system 400 without authentication and processes a financial transaction to be relayed.

However, when user authentication is not possible using either one of Fingerprint 1 information and Finger vein 1 information by the client terminal 200 in operation S186 or in operation S190, the process proceeds to operation S196, and connection of the financial transaction relay server 100 is blocked so that the financial transaction relay server 100 is not allowed to process an electronic financial transaction and an electronic commerce transaction.

FIG. 13 is a flowchart showing a different processing order of a financial transaction relay system having a multi-safety lock function using Fingerprint 2 authentication according to embodiments of the present invention.

Referring to FIG. 13, in a financial transaction relay system 2 of embodiments of the present invention, a client terminal 200 is connected to a financial transaction relay server 100 via a communication network 4 in operation S150 and joins the server as a member in operation S152. In this case, the client terminal 200 inputs personal information of the client such as a name, an ID, a password, a phone number, and an e-mail address.

In operation S154, the client terminal 200 acquires Finger vein 2 information and Fingerprint 2 information via a Finger vein 2 recognizer 210 and a Fingerprint 2 recognizer 220, and when the Finger vein 2 information and the Fingerprint 2 information are transmitted to the financial transaction relay server 100 via the communication network 4, the financial transaction relay server 100 registers the Finger vein 2 information and the Fingerprint 2 information corresponding to the client terminal 200. In this case, the financial transaction relay server 100 stores the Finger vein 2 information and the Fingerprint 2 information in a database.

In operation S156, to perform an electronic financial transaction and an electronic commerce transaction, the financial transaction relay server 100 firstly recognizes Fingerprint 2. In operation S158, the financial transaction relay server 100 determines whether Fingerprint 2 matches the Fingerprint 2 information stored in the database and authenticates a user of the client terminal 200.

As a result of the determination, when the two pieces of information match, the financial transaction relay server 100 secondly recognizes Finger vein 2 in operation S164 and determines whether Finger vein 2 matches the Finger vein 2 information stored in the database in operation S166.

As a result of the determination, when the two pieces of Finger vein 2 information match, the process proceeds to operation S168 and, thirdly, firewall protection is released in a multi-safety lock module 110 through a middleware verification process unit 120 so that the database of the financial transaction relay server 100 may be accessed. Then, in operation S170, the financial transaction relay server 100 is connected to an electronic financial transaction system 300 or an electronic commerce system 400 without authentication and processes a financial transaction to be relayed.

However, when either one of Finger vein 2 information and Fingerprint 2 information does not match Finger vein 1 and Fingerprint 1 of the client terminal 200 in operation S158 or in operation S166, the process proceeds to operation S172, and connection of the financial transaction relay server 100 is blocked so that the financial transaction relay server 100 is not allowed to process an electronic financial transaction and an electronic commerce transaction.

This is because, in the case of Fingerprint 2 recognition, since authentication using Fingerprint 2 recognition is possible only when one is alive and thus is only possible by oneself, the security effect is unchanged even without another additional password process.

FIG. 14 is a flowchart illustrating a different processing order of a financial transaction relay system having a multi-safety lock function in which user authentication is processed by simultaneously scanning Fingerprint 2 and Finger vein 2 according to embodiments of the present invention. This embodiment is performed when user identification is difficult due to Fingerprint 2 information and Finger vein 2 information being identical or similar to other pieces of finger vein information. First user authentication is processed using Fingerprint 2 information, and when user identification in the first user authentication is difficult, Finger vein 2 information is used secondly to process user authentication.

That is, referring to FIG. 14, in a financial transaction relay system 2 of embodiments of the present invention, in operation S180, Finger vein 2 and Fingerprint 2 are simultaneously scanned by a Finger vein 2 recognizer 210 and a Fingerprint 2 recognizer 220 of a client terminal 200, and the Finger vein 2 information and the Fingerprint 2 information are provided to a financial transaction relay server 100.

In operation S182, the financial transaction relay server 100 recognizes the Fingerprint 2 information and the Finger vein 2 information. In operation S184, the financial transaction relay server 100 compares the Fingerprint 2 information with other pieces of Fingerprint 2 information stored in a database and determines whether the Fingerprint 2 information is unique.

As a result of the determination, when the Fingerprint 2 information is unique, the process proceeds to operation S186. When the Fingerprint 2 information is not unique, that is, when user identification is difficult due to the Fingerprint 2 information being identical or similar to other pieces of finger vein information, the financial transaction relay server 100 compares the Finger vein 2 information with another piece of Finger vein 2 information stored in a database and determines whether the Finger vein 2 information is unique in operation S186.

As a result of the determination, when the Finger vein 2 information is unique, the process proceeds to operation S188, and the financial transaction relay server 100 processes user authentication for releasing a firewall protection or blocking the connection.

In operation S192, firewall protection is released in a multi-safety lock module 110 through a middleware verification process unit 120 so that the database of the financial transaction relay server 100 may be accessed. Then, in operation S194, the financial transaction relay server 100 is connected to an electronic financial transaction system 300 or an electronic commerce system 400 without authentication and processes a financial transaction to be relayed.

However, when user authentication is not possible using either one of Fingerprint 2 information and Finger vein 2 information by the client terminal 200 in operation S186 or in operation S190, the process proceeds to operation S196, and connection of the financial transaction relay server 100 is blocked so that the financial transaction relay server 100 is not allowed to process an electronic financial transaction and an electronic commerce transaction.

As described above, embodiments of the present invention may be implemented using methods according to the above-described six matrices in conjunction with the above-described embodiment. Accordingly, by combining two or more pieces of information as human body information, a risk of imitation or hacking may be eliminated, and embodiments of the present invention may be the only method capable of technically solving error problems of fingerprints or finger veins.

The system of such an electronic payment system may be described as an embodiment as follows.

An electronic payment system using gender identification fingerprint and/or finger vein recognition may be provided which includes: a communication network; a customer client connected to the communication network and configured to acquire Fingerprint 1 information and/or Finger vein 1 information of a customer himself or herself and information which is input by a man as “1” and a woman as “2;” a franchisee client connected to the communication network and configured to acquire Fingerprint 1 information and/or Finger vein 1 information of the customer client and information which is input by a man as “1” and a woman as “2” when a commerce transaction occurs; and a payment service server configured to receive the Fingerprint 1 information and/or the Finger vein 1 information and information which is input by a man as “1” and a woman as “2” from the customer client via the communication network and register the Fingerprint 1 information and/or the Finger vein 1 information in correspondence with a payment method, to compare the input two pieces of fingerprint information and/or finger vein information and the input two pieces of information which are input by a man as “1” and a woman as “2” when the Fingerprint 1 information and/or the Finger vein 1 information and information which is input by a man as “1” and a woman as “2” are transmitted from the customer client and authenticate the customer, and to process payment through the payment method corresponding to the Fingerprint 1 information and/or the Finger vein 1 information and information which is input by a man as “1” and a woman as “2.”

In addition, a method of processing an electronic payment system using fingerprint recognition and/or finger vein recognition includes: providing the fingerprint and/or finger vein payment application to the fingerprint and/or finger vein payment service server of the electronic payment system, connecting a customer client to the fingerprint and/or finger vein payment service server via a communication network, and downloading the fingerprint and/or finger vein payment application to provide the fingerprint and/or finger vein payment application therein; activating, by the customer client, the fingerprint and/or finger vein payment application, acquiring Fingerprint 1 information and/or finger vein information of a customer himself or herself through a first fingerprint recognizer and/or a finger vein recognizer of the customer client, and providing the acquired Fingerprint 1 information and/or finger vein information to the fingerprint and/or finger vein payment service server via the communication network; activating, by the customer client, the provided fingerprint and/or finger vein payment application, acquiring information which are input by a man as “1” and a woman as “2” by classifying the customer client, and providing the acquired male information “1” and the acquired female information “2” to the fingerprint and/or finger vein payment service server via the communication network; storing, by the fingerprint and/or finger vein payment service server, the Fingerprint 1 information and/or the Finger vein 1 information provided from the customer client and the information which are input by a man as “1” and a woman as “2” in a database, and transmitting the Fingerprint 1 information and/or the Finger vein 1 information and the information which are input by a man as “1” and a woman as “2” to a credit card company server via the communication network; and matching, by the credit card company server, the Fingerprint 1 information and/or the Finger vein 1 information and the information which are input by a man as “1” and a woman as “2” transmitted from the fingerprint and/or finger vein payment service server with a registered payment method of the customer.

Next, a method of processing an electronic payment system using gender identification fingerprint and/or finger vein recognition includes: recognizing Fingerprint 1 information and/or finger vein information and information which are input by a man as “1” and a woman as “2” from a first fingerprint recognizer and/or a finger vein recognizer of a franchisee client connected to the communication network when commercial transaction occurs at a franchisee, and transmitting the Fingerprint 1 information and/or the Finger vein 1 information and the information which are input by a man as “1” and a woman as “2” and payment information according to occurrence of commercial transaction to the fingerprint and/or finger vein payment service server to request payment approval; comparing and analyzing, by the fingerprint and/or finger vein payment service server, the first fingerprint information and/or the finger vein information transmitted from the franchisee client with the Fingerprint 1 information and/or the Finger vein 1 information registered in the database to determine customer authentication; as a result of the determination, when the registered two pieces of fingerprint information and/or finger vein information and the information which are input by a man as “1” and a woman as “2” match, requesting, by the fingerprint and/or finger vein payment service server, payment approval from the credit card company server so that the payment is performed on the payment method of the customer which is matched with the Fingerprint 1 information and/or finger vein information and the information which are input by a man as “1” and a woman as “2;” and when the payment is approved through the payment method of the customer corresponding to the Fingerprint 1 information and/or the Finger vein 1 information and the information which are input by a man as “1” and a woman as “2,” notifying, by the credit card company server, the franchisee client and the fingerprint and/or finger vein payment service server that the payment is approved.

In addition, the information which is input by a man as “1” and a woman as “2” as information for distinguishing between males and females may be an option at the time of registration of the fingerprint and/or the finger vein by downloading an application from an electronic payment system so that it can meet the needs of various consumers.

Therefore, when the probability of an error of one fingerprint is one in one hundred thousand, a recognition rate thereof is lowered to 80%, and when a user is authenticated only when two conditions are satisfied using two modules, the probability of an error of one fingerprint turns out to be one in 6.4 billion, which corresponds to a square of one in eighty thousand. Since the probability is sufficient to cover the whole population of the world, a conclusion is drawn that two identical fingerprints cannot exist in reality.

Furthermore, even in the case of providing the electronic payment system and method for determining between males and females in order to reduce a false acceptance rate as described in embodiments of the present invention, the false acceptance rate may be reduced to a half thereof, and when the database storing the information is also separate from males and females, the capacity simplicity and the speed will also be doubled.

The probability of an error in the case of finger veins is one in one hundred million, which is even lower. Thus, when finger veins and fingerprints are combined, the whole population of the world is definitely covered, and the conclusion may be drawn that two identical fingerprints cannot exist in reality.

An integrated module for linking fingerprint and finger vein algorithms to realize the above case may be described as follows.

FIG. 16 is a diagram showing an input and output integrated module for linking fingerprint and finger vein algorithms. FIG. 17 is a flowchart showing a process of requesting fingerprint and finger vein registration. FIG. 18 is a flowchart showing a process of requesting fingerprint and finger vein authentication. FIG. 19 is a flowchart showing a process of requesting fingerprint and finger vein deletion.

As shown in FIG. 16, an input and output integrated module U1 for simultaneously linking fingerprint and finger vein algorithms includes a fingerprint module U2, a finger vein module U3, and a conversion module U4.

First, the fingerprint module U2 will be described.

A GND line 1 of the fingerprint module U2 is a reference of a (−) voltage circuit and functions as a ground of 0 V, an RX line 2 is a serial data reception port and functions to control the fingerprint module, a TX line 3 is serial data transmission port and functions to read a status of the fingerprint module, and a VCC line 4 is a (+) voltage reference of a power supply circuit and functions to input a voltage of +5 V. In the above configuration, a fingerprint is scanned in an image sensor and the scanned fingerprint image is compared with a previously-stored image, and when there is a person having a fingerprint which is identical to the previously-stored image, a registered authentication code of the person is output via serial communication (here, RS232 communication is applied as an embodiment).

Here, the RS232 communication is a serial communication standard.

Next, the finger vein module U3 will be described.

A GND line 1 of the finger vein module U3 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference of a power supply circuit and functions to input a voltage of +5 V. In the above configuration, a vein is scanned in a camera image sensor after light of an infrared LED passes through a finger and the scanned finger vein image is compared with a previously-stored image, and when there is a person having a finger vein which is identical to the previously-stored image, a registered authentication code of the person is output via serial communication (here, RS485 communication is applied as an embodiment).

Here, the RS485 communication is a serial communication standard.

Next, the RS485-232 communication conversion module U4 will be described.

A GND line 1 at a left side of the conversion module U4 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference and functions to input a voltage of +5 V. In the above configuration, an RS485 communication signal output from the finger vein module is received and converted into an RS232 communication signal and output.

In addition, a DI line 5 at a right side of the conversion module U4 is an RS232 serial communication reception port and functions to receive data, an RE line 6 is an RS485 communication control port and functions to control a reception and transmission status of the RS485 communication module, a DE line 7 is an RS485 communication control port and functions to control the reception and transmission status of the RS485 communication module, and an RO line 8 is an RS232 serial communication transmission port, which functions to transmit a command, and is linked with the integrated module U1.

Next, a fingerprint and finger vein input and Universal Serial Bus (USB) output integrated module U1 will be described.

A D1/TX line 1 of the integrated module U1 is an RS232 serial communication transmission port and functions to transmit data to a computer, a DO/RX line 2 is an RS232 serial communication reception port and functions to receive data from the computer, a GND line 4 is a (−) voltage reference and functions as a ground of 0 V, a D2 line 5 is an RS232 serial communication transmission line of the fingerprint module U2 and functions to transmit a command to the fingerprint module, a D3 line 6 is an RS232 serial communication reception line of the fingerprint module U2 and functions to receive a status value of the fingerprint module, a D8 line 11 is an RS232 serial communication transmission port of the RS485-232 communication conversion module U4 and functions to control the finger vein module U3, a D9 line 12 is an RS485 communication control port of the RS485-232 communication conversion module U4 and functions to control a reception and transmission status of the RS485 communication module, a D10 line 13 is an RS485 communication control port of the RS485-232 communication conversion module U4 and functions to control the reception and transmission status of the RS485 communication module, a D11 line 14 is an RS232 serial communication reception port of the RS485-232 communication conversion module U4 and functions to read a status of the finger vein module U3, a 5V line 27 is a PIN for outputting a voltage of +5 V and functions to supply a 5 V voltage of the fingerprint module U2, the finger vein module U3, and the RS485 communication conversion module U4, a GND line 29 is a (−) voltage reference and functions as a ground of 0 V, and a VIN line 30 is a (+) voltage reference and functions to input a voltage of +5 V. In the above configuration, a fingerprint authentication code (a unique number of a customer whose fingerprint is registered) output from the fingerprint module U2 and a finger vein authentication code (a unique number of a customer whose finger vein is registered) output from the finger vein module U3 are converted into RS232 communication signals in the conversion module U4, the converted codes are received in the integrated module U1, and when the fingerprint authentication code and the finger vein authentication code match, the corresponding authentication code is output via USB.

The fingerprint and finger vein algorithm may be expressed as follows.

```
int getfingerauthorization(int fingerprintcode,int fingerveincode)
{
  if( fingerprintcode>0 && fingerveincode>0 && fingerprintcode==
  fingerveincode) )
  {
    return fingerprintcode;
  }
  return 0;
}
```

The above algorithm is an algorithm in which a fingerprint authentication code and a finger vein authentication code are received from the integrated module U1 and the authentication codes are allowed only when the fingerprint and the finger vein are of the same person.

The following is a more detailed description.

The fingerprint module U2 searches for a fingerprint, and when there is a person having a fingerprint matching the corresponding fingerprint, a code number of the person is output.

The finger vein module U3 search for a finger vein, and when there is a person having a finger vein matching the corresponding finger vein, a code number of the person is output.

The fingerprint code of the fingerprint module U2 and the finger vein code of the finger vein module U3 are input as “fingerprintcode” and “fingerveincode” which are arguments of a function “getfingerauthorization” of the above algorithm, and when values of the two arguments are valid and the unique numbers of the two registered customer match, the fingerprint and the finger vein integrated module outputs the code number of the corresponding person.

Otherwise, when the fingerprint code and the finger vein code are invalid or do not match, an error code of 0 is output.

Next, a procedure for registering, authenticating, or deleting fingerprints and finger veins in a recognizer or a bank that store the fingerprints and the finger veins therein will be described.

First, as shown in FIGS. 17 to 19, as an operation of registering a fingerprint and a finger vein, a registration request is made in a fingerprint and finger vein recognizer (S311).

When there is a registration request from the fingerprint and finger vein recognizer, a fingerprint and a finger vein are first scanned by the recognizer with a finger of a person who is desired to be registered (S312).

Next, the fingerprint and the finger vein are scanned secondly by the recognizer with the finger of the person who is desired to be registered after the first registration in the fingerprint and finger vein recognizer (S313).

Next, the fingerprint and the finger vein are scanned thirdly by the recognizer with the finger of the person who is desired to be registered after the first registration in the fingerprint and finger vein recognizer (S314).

In the operation of three registrations in the fingerprint and finger vein recognizer, it is determined whether all of the three scanned images match in order to measure the accuracy of the registrations (S315).

As described above, in the operation of the three registrations in the fingerprint and finger vein recognizer, when all of the three scanned images do not match, the process is resumed, and when all of the three scanned images match, the registration is completed (S316).

Such a process is performed three times to register accurate fingerprint and finger vein images.

Next, as an operation of authenticating the registration of the fingerprint and the finger vein, an authentication request is made in the fingerprint and finger vein recognizer (S321).

The fingerprint and finger vein images of the corresponding person are scanned by the fingerprint and finger vein recognizer (S322).

In the fingerprint and finger vein recognizer, the fingerprint and finger vein images, which are scanned with the finger of the registered person, are compared with each other (S323).

In the fingerprint and finger vein recognizer, it is determined whether the scanned images match (S324).

As described above, when all of the scanned images in the fingerprint and finger vein recognizer do not match with each other, the process is resumed, and the authentication is completed (S325).

Next, as an operation of deleting the registration of the fingerprint and the finger vein, a deletion request is made in the fingerprint and finger vein recognizer (S331).

A code of the corresponding person to be deleted is input to the fingerprint and finger vein recognizer (S332).

In the fingerprint and finger vein recognizer, it is determined whether an image of the code to be registered is deleted (S333).

When the scanned image is not deleted in the fingerprint and finger vein recognizer, the process is resumed, and when the scanned image is deleted, the authentication is completed (S334).

FIG. 20 is a diagram showing an input and output integrated module for linking Fingerprint 1 and Fingerprint 2 algorithms.

As shown in FIG. 20, an input and output integrated module U1 for simultaneously linking Fingerprint 1 and Fingerprint 2 algorithms includes a Fingerprint 1 module U2 and a Fingerprint 2 module U3.

First, the Fingerprint 1 module U2 will be described.

A GND line 1 of the Fingerprint 1 module U2 is a reference of a (−) voltage circuit and functions as a ground of 0 V, an RX line 2 is a serial data reception port and functions to control the Fingerprint 1 module, a TX line 3 is a serial data transmission port and functions to read a status of the Fingerprint 1 module, and a VCC line 4 is a (+) voltage reference of a power supply circuit and functions to input a voltage of +5 V. In the above configuration, in an image sensor, a fingerprint is scanned, and the scanned fingerprint image is compared with a previously-stored image, and when there is a person having a fingerprint which is identical to the previously-stored image, a registered authentication code of the corresponding person is output as an RS232 communication signal.

Here, the RS232 communication is a serial communication standard.

Next, the Fingerprint 2 module U3 will be described.

A GND line 1 of the Fingerprint 2 module U3 is a reference of the (−) voltage circuit and functions as a ground of 0 V, an RX line 2 is a serial data reception port and functions to control the fingerprint module, a TX line 3 is a serial data transmission port and functions to read a status of the fingerprint module, and a VCC line 4 is a (+) voltage reference of a power supply circuit and functions to input a voltage of +5 V. In the above configuration, in an image sensor, a fingerprint is scanned, and the scanned fingerprint image is compared with a previously-stored image, and when there is a person having a fingerprint which is identical to the previously-stored image, a registered authentication code of the corresponding person is output as an RS232 communication signal.

Here, the RS232 communication is a serial communication standard.

In addition, a Fingerprint 1 (U2) and the Fingerprint 2 (U3) input and USB output integrated module U1 will be described.

A D1/TX line 1 of the integrated module U1 is an RS232 serial communication transmission port and functions to transmit data to a computer, a DO/RX line 2 is an RS232 serial communication reception port and functions to receive data from the computer, a GND line 4 is a (−) voltage reference and functions as a ground of 0 V, a D2 line 5 is an RS232 serial communication transmission line of the Fingerprint 1 module U2 and functions to transmit a command to the Fingerprint 1 module, a D3 line 6 is an RS232 serial communication reception line of the Fingerprint 1 module U2 and functions to receive a status value of the Fingerprint 1 module, a D9 line 12 is an RS232 serial communication transmission line of the Fingerprint 2 module U3 and functions to transmit a command to the Fingerprint 2 module, a D10 line 13 is an RS232 serial communication reception line of the Fingerprint 2 module U3 and functions to receive a status value of the Fingerprint 2 module, a 5V line 27 is a PIN for outputting a voltage of +5 V and functions to supply a 5 V voltage of the Fingerprint 1 module U2 and the Fingerprint 2 module U3, a GND line 29 is a (−) voltage reference and functions as a ground of 0 V, and a VIN line 30 is a (+) voltage reference and functions to input a voltage of +5 V. In the above configuration, a Fingerprint 1 authentication code (a unique number of a customer whose fingerprint is registered) output from the Fingerprint 1 module U2 and a Fingerprint 2 authentication code (a unique number of a customer whose fingerprint is registered) output from the Fingerprint 2 module U3 are received by the integrated module U1, and when the authentication code of the Fingerprint 1 (U2) and the authentication code of the Fingerprint 2 (U3) match, the corresponding authentication code is output via USB.

The Fingerprint 1 and Fingerprint 2 algorithms may be expressed as follows.

```
      int getfingerauthorization(int fingerprintcode1,int fingerprintcode2)
      {
        if( fingerprintcode1>0 && fingerprintcode2>0 &&
fingerprintcode1==fingerprintcode2) )
        {
          return fingerprintcode1;
        }
        return 0;
      }
```

The above algorithm is an algorithm in which a Fingerprint 1 (U2) authentication code and a Fingerprint 2 (U3) authentication code are received from the integrated module U1, and the authentication codes are allowed only when the Fingerprint 1 (U2) and the Fingerprint 2 (U3) are of the same person.

The following is a more detailed description.

The Fingerprint 1 module U2 searches for a Fingerprint 1, and when there is a person having a fingerprint matching the corresponding fingerprint, a unique number of the corresponding person is output.

The Fingerprint 2 module U3 searches for a Fingerprint 2, and when there is a person having a fingerprint matching the corresponding fingerprint, a unique number of the corresponding person is output.

The fingerprint code of the Fingerprint 1 module U2 and the fingerprint code of the Fingerprint 2 module U3 are input as “fingerprintcode1” and “fingerprintcode2” which are arguments of a function “getfingerauthorization” of the above algorithm, and when values of the two arguments are valid and the unique numbers (a person code value) of the two registered customer match, the Fingerprint 1 (U2) and the Fingerprint 2 (U3) integrated module outputs the code number of the corresponding person.

Otherwise, when the fingerprint codes are invalid or do not match, an error code of 0 is output.

Here, since a procedure for registering, authenticating, or deleting the fingerprints in a recognizer or a bank that store the fingerprints therein is the same as the procedure for the fingerprints and the finger veins, the procedure is omitted.

FIG. 21 is a diagram showing an input and output integrated module for linking Fingerprint vein 1 and Fingerprint vein 2 algorithms.

As shown in FIG. 21, an input and output integrated module U1 for simultaneously linking Finger vein 1 and Finger vein 2 algorithms includes a Finger vein 1 module U2 and a Finger vein 2 module U3.

First, the Finger vein 1 module U2 will be described.

A GND line 1 of the Finger vein 1 module U2 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference of the power supply circuit and functions to input a voltage of +5 V. In the above configuration, light of an infrared LED passes through a finger, and then in a camera image sensor, a vein is scanned and the scanned vein image is compared with a previously-stored vein image, and when there is a person having a finger vein which is identical to the previously-stored vein image, a registered authentication code of the corresponding person is output as an RS485 communication signal.

Here, the RS485 communication is a serial communication standard.

Next, the RS485-232 conversion module U4 will be described.

A GND line 1 at a left side of the conversion module U4 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference and functions to input a voltage of +5 V. In the above configuration, an RS485 communication signal output from the Finger vein 1 module U2 is received and converted into an RS232 communication signal and output.

In addition, a DI line 5 at a right side of the conversion module U4 is an RS232 serial communication reception port and functions to receive data, an RE line 6 is an RS485 communication control port and functions to control a reception and transmission status of the RS485 communication module, a DE line 7 is an RS485 communication control port and functions to control the reception and transmission status of the RS485 communication module, and an RO line 8 is an RS232 serial communication transmission port, which functions to transmit a command, and is linked with the integrated module U1.

Next, the Finger vein 2 module U3 will be described.

A GND line 1 of the Finger vein 2 module U3 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference of the power supply circuit and functions to input a voltage of +5 V. In the above configuration, light of an infrared LED passes through a finger, and then in a camera image sensor, a vein is scanned and the scanned vein image is compared with a previously-stored vein image, and when there is a person having a finger vein which is identical to the previously-stored vein image, a registered authentication code of the corresponding person is output as an RS485 communication signal.

Here, the RS485 communication is a serial communication standard.

Next, the RS485-232 conversion module U5 will be described.

A GND line 1 at a left side of the conversion module U5 is a (−) voltage reference and functions as a ground of 0 V, an A line 2 is a serial communication standard RS485 communication A port and functions to receive and transmit data, a B line 3 is a serial communication standard RS485 communication B port and functions to receive and transmit data, and a VCC line 4 is a (+) voltage reference and functions to input a voltage of +5 V. In the above configuration, an RS485 communication signal output from the Finger vein 2 module U3 is received and converted into an RS232 communication signal and output.

In addition, a DI line 5 at a right side of the conversion module U5 is an RS232 serial communication reception port and functions to receive data, an RE line 6 is an RS485 communication control port and functions to control a reception and transmission status of the RS485 communication module, a DE line 7 is an RS485 communication control port and functions to control the reception and transmission status of the RS485 communication module, and an RO line 8 is an RS232 serial communication transmission port, which functions to transmit a command, and is linked with the integrated module U1.

In addition, the Finger vein 1 (U2) and the Finger vein 2 (U3) input and USB output integrated module U1 will be described.

A D1/TX line 1 of the integrated module U1 is an RS232 serial communication transmission port and functions to transmit data to a computer, a DO/RX line 2 is an RS232 serial communication reception port and functions to receive data from the computer, a GND line 4 is a (−) voltage reference and functions as a ground of 0 V, a D2 line 5 is 2 a 32 serial communication transmission port of the RS485-232 conversion module U4 and functions to control the finger vein module U2, a D3 line 6 is an RS485 control port of the RS485-232 conversion module U4 and functions to control a reception and transmission status of the RS485 module, a D4 line 7 is an RS485 control port of the RS485-232 conversion module U4 and functions to control the reception and transmission status of the RS485 module, a D5 line 8 is an RS232 serial communication reception port of the RS485-232 conversion module U4 and functions to read a status of the finger vein module U2, a D8 line 11 is an RS232 serial communication transmission port of the RS485-232 conversion module U5 and functions to control the finger vein module U3, a D9 line 12 is an RS485 control port of the RS485-232 conversion module U5 and functions to control the reception and transmission status of the RS485 module, a D10 line 13 is an RS485 control port of the RS485-232 conversion module U5 and functions to control the reception and transmission status of the RS485 module, a D11 line 14 is an RS232 serial communication reception port of the RS485-232 conversion module U5 and functions to read the status of the finger vein module U3, a 5V line 27 is a PIN for outputting a voltage of +5 V and functions to supply a 5 V voltage of the Finger vein 1 module U2, the Finger vein 2 module U3, the RS485 modules U4 and U5, a GND line 29 is a (−) voltage reference and functions as a ground of 0 V, and a VIN line 30 is a (+) voltage reference and functions to input a voltage of +5 V. In the above configuration, a finger vein authentication code (a unique number of a customer whose finger vein is registered) output from the Finger vein 1 module U2 and a finger vein authentication code (a unique number of a customer whose finger vein is registered) output from the Finger vein 2 module U3 are received by the integrated module U1, and when the authentication code of the Finger vein 1 (U2) and the authentication code of the Finger vein 2 (U3) match, the corresponding authentication code is output via USB.

The Finger vein 1 and the Finger vein 2 algorithms may be expressed as follows.

```
      int getfingerauthorization(int fingerveincode1,int fingerveincode2)
      {
        if( fingerveincode1>0 && fingerveincode2>0 &&
fingerveincode1==fingerveincode2) )
        {
          return fingerveincode1;
        }
        return 0;
      }
```

The above algorithm is an algorithm in which a Finger vein 1 (U2) authentication code and a Finger vein 2 (U3) authentication code are received from the integrated module U1 and the authentication codes are allowed only when the Finger vein 1 (U2) and the Finger vein 2 (U3) are of the same person.

The following is a more detailed description.

The Finger vein 1 module U2 searches for a Finger vein 1, and when there is a person having a finger vein matching the corresponding finger vein, a unique number of the corresponding person is output.

The Finger vein 2 module U3 searches for a Finger vein 2, and when there is a person having a finger vein matching the corresponding finger vein, a unique number of the corresponding person is output.

The finger vein code of the Finger vein 1 module U2 and the finger vein code of the Finger vein 2 module U3 are input as “fingerveincode1” and “fingerveincode2” which are arguments of a function “getfingerauthorization” of the above algorithm, and when values of the two arguments are valid and the two unique numbers (a person code value) of the registered customer match, the Finger vein 1(U2) and Finger vein 2(U3) integrated module outputs the code number of the corresponding person.

Otherwise, when finger vein codes are invalid or do not match, an error code of 0 is output.

Here, since a procedure for registering, authenticating, or deleting the fingerprints in a recognizer or a bank that stores the finger veins therein is the same as the procedure of the fingerprints and the finger veins, the procedure is omitted.

As described above, when the fingerprint and the finger vein are operated by a method of registering, authenticating, or deleting the fingerprints and the finger veins in a recognizer or a bank that store the fingerprints and the finger veins therein, a degree of recognition of the fingerprint and the finger vein can be further increased and the operation of the fingerprint and finger vein may be simplified.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An input and output integrated module for simultaneously linking biometric information algorithms, the input and output integrated module comprising an integrated module for simultaneously authenticating fingerprints and finger veins which includes a fingerprint module, a finger vein module, and a conversion module, wherein:
the fingerprint module scans a fingerprint in an image sensor, compares the scanned image with a previously-stored image, and outputs a registered authentication code of a corresponding person via RS232 serial communication when there is a person having a fingerprint which is identical to the previously-stored image;
the finger vein module scans a finger vein in a camera image sensor after light of an infrared light-emitting diode passes through a finger, compares the scanned image with a previously-stored finger vein image, and outputs a registered authentication code of a corresponding person as an RS485 communication signal when there is a person having a finger vein which is identical to the previously-stored image; and
the conversion module receives an RS485 communication signal output from the finger vein module to convert the RS485 communication signal into an RS232 communication signal as in the fingerprint module and output the converted RS232 communication signal, and receives a fingerprint authentication code output from the fingerprint module and a finger vein authentication code output from the finger vein module to output a corresponding authentication code via Universal Serial Bus when the fingerprint authentication code matches the finger vein authentication code.

2. The input and output integrated module of claim 1, wherein, in the fingerprint module, a GND line 1 is a (−) voltage circuit, an RX line 2 is a serial data reception port, a TX line 3 is a serial data transmission port, and a VCC line 4 is a (+) voltage reference of the power supply circuit and, by using the GND line 1, the RX line 2, the TX line 3, and the VCC line 4, a fingerprint is scanned in the image sensor and the scanned fingerprint image is compared with a previously-stored image, and when there is a person having a fingerprint which is identical to the previously-stored image, a registered authentication code of the person is output as an RS232 communication signal.

3. The input and output integrated module of claim 1, wherein, in the finger vein module, a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in the conversion module GND line 1 at a left side, is a (−) voltage reference, an A line 2 is a serial communication standard RS485 communication A port, a B line 3 is a serial communication standard RS485 communication B port, a VCC line 4 is a (+) voltage reference, a DI line 5 at a right side of the conversion module which is linked with the finger vein module is an RS232 serial communication reception port, an RE line 6 is an RS485 communication control port, a DE line 7 is an RS485 communication control port, and an RO line 8 is an RS232 serial communication transmission port.

4. The input and output integrated module of claim 3, wherein, in the integrated module, a D1/TX line 1 is an RS232 serial communication transmission port, a DO/RX line 2 is an RS232 serial communication reception port, a GND line 4 is a (−) voltage reference, a D2 line 5 is an RS232 serial communication transmission line of the fingerprint module, D3 line 6 is an RS232 serial communication reception line of the fingerprint module, a D8 line 11 is an RS232 serial communication transmission port of an RS485-232 communication conversion module and functions to control the finger vein module, a D9 line 12 is an RS485 communication control port of the RS485-232 communication conversion module, a D10 line 13 is an RS485 communication control port of the RS485-232 communication conversion module, a D11 line 14 is an RS232 serial communication reception port of the RS485-232 communication conversion module, a 5V line 27 is a PIN for outputting a voltage of +5 V, a GND line 29 is a (−) voltage reference, and a VIN line 30 is a (+) voltage reference and, by using the D1/TX line 1, the DO/RX line, the GND line 4, the D2 line 5, the D3 line 6, the D8 line 11, the D9 line 12, the D10 line 13, the D11 line 14, the 5V line 27, the GND line 29, and the VIN line 30, a fingerprint authentication code output from the fingerprint module and a finger vein authentication code output from the finger vein module are converted into RS232 communication signals in the conversion module, the converted codes are received in the integrated module, and when the fingerprint authentication code matches the finger vein authentication code, the corresponding authentication code is output via USB.

5. The input and output integrated module of claim 1, wherein “fingerprintcode” and “fingerveincode,” which are arguments of a function “getfingerauthorization” of an algorithm with respect to a fingerprint authentication code and a finger vein authentication code are received, and when values of the two arguments are valid and unique numbers of the two registered customer match, a code number of a corresponding person is output in the integrated module for simultaneously authenticating the fingerprints and the finger veins.

6. An input and output integrated module for simultaneously linking biometric information algorithms, the input and output integrated module comprising an integrated module for simultaneously authenticating Fingerprint 1 and Fingerprint 2 which includes a Fingerprint 1 module and a Fingerprint 2 module, wherein: the Fingerprint 1 module scans a fingerprint in an image sensor, compares the scanned image with a previously-stored image, and outputs a registered authentication code of a corresponding person as a specific serial communication signal when there is a person having a fingerprint which is identical to the previously-stored image; and the Fingerprint 2 module scans a fingerprint in an image sensor, compares the scanned image with a previously-stored image to output a registered authentication code of a corresponding person as a specific serial communication signal when there is a person having a fingerprint which is identical to the previously-stored image, and receives a Fingerprint 1 authentication code output from the Fingerprint 1 module and a Fingerprint 2 authentication code output from the Fingerprint 2 module in the integrated module to output a corresponding authentication code via Universal Serial Bus when the Fingerprint 1 matches Fingerprint 2 authentication code.

7. The input and output integrated module of claim 6, wherein, in the Fingerprint 1 module, a GND line 1 is a (−) voltage circuit, an RX line 2 is a serial data reception port, a TX line 3 is a serial data transmission port, and a VCC line 4 is a (+) voltage reference of the power supply circuit and, by using the GND line 1, the RX line 2, the TX line 3, and the VCC line 4, a fingerprint is scanned in the image sensor and the scanned fingerprint image is compared with a previously-stored image, and when there is a person having a fingerprint which is identical to the previously-stored image, a registered authentication code of the person is output as an RS232 communication signal, in the Fingerprint 2 module, a GND line 1 is a reference of the (−) voltage circuit, an RX line 2 is a serial data reception port, a TX line 3 is a serial data transmission port, and a VCC line 4 is a (+) voltage reference of the power supply circuit, in the above configuration, a fingerprint is scanned in the image sensor and the scanned fingerprint image is compared with a previously-stored image, and when there is a person having a fingerprint which is identical to the previously-stored image, a registered authentication code of the person is output as an RS232 communication signal, in the integrated module, a D1/TX line 1 is an RS232 serial communication transmission port, a DO/RX line 2 is an RS232 serial communication reception port, a GND line 4 is a (−) voltage reference, a D2 line 5 is an RS232 serial communication transmission line of the Fingerprint 1 module, a D3 line 6 is an RS232 serial communication reception line of the Fingerprint 1 module, a D9 line 12 is an RS232 serial communication transmission line of the Fingerprint 2 module, a D10 line 13 is an RS232 serial communication reception line of the Fingerprint 2 module, a 5V line 27 is a PIN for outputting a voltage of +5 V, a GND line 29 is a (−) voltage reference, and a VIN line 30 is a (+) voltage reference and, by using the D1/TX line 1, the DO/RX line 2, the GND line 4, the D2 line 5, the D3 line 6, the D9 line 12, the D10 line 13, the 5V line 27, the GND line 29, and the VIN line 30, a Fingerprint 1 authentication code output from the Fingerprint 1 module and a Fingerprint 2 authentication code output from the Fingerprint 2 module are received in the integrated module, and when an authentication code of the Fingerprint 1 and an authentication code of the Fingerprint 2 match, the corresponding authentication codes are output via USB.

8. An input and output integrated module for simultaneously linking biometric information algorithms, the input and output integrated module comprising an integrated module for simultaneously authenticating Finger vein 1 and Finger vein 2 which includes a Finger vein 1 module and a Finger vein 2 module, wherein:
the Finger vein 1 module scans a finger vein in an image sensor, compares the scanned image with a previously-stored image, and outputs a registered authentication code of a corresponding person as a specific serial communication signal when there is a person having a finger vein which is identical to the previously-stored image; and
the Finger vein 2 module scans a finger vein in an image sensor, compares the scanned image with a previously-stored image to output a registered authentication code of a corresponding person as a specific serial communication signal when there is a person having a finger vein which is identical to the previously-stored image, and receives a Finger vein 1 authentication code output form the Finger vein 1 module and a Finger vein 2 authentication code output from the Finger vein 2 module in the integrated module to output a corresponding authentication code via Universal Serial Bus when an authentication code of the Finger vein 1 matches an authentication code of the Finger vein 2.

9. The input and output integrated module of claim 8, wherein, in the Finger vein 1 module, a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in a conversion module, a GND line 1 at a left side is a the (−) voltage reference, an A line 2 is a serial communication standard RS485 communication A port, a B line 3 is a serial communication standard RS485 communication B port, a VCC line 4 is a (+) voltage reference, a DI line 5 at a right side of the conversion module which is linked with the Finger vein 1 module is an RS232 serial communication reception port, an RE line 6 is an RS485 communication control port, a DE line 7 is an RS485 communication control port, and an RO line 8 is an RS232 serial communication transmission port, which is linked with the integrated module, in the Finger vein 2 module, a GND line 1 is a (−) voltage reference, an A line 2 is a serial communication standard RS485 communication A port, a B line 3 is a serial communication standard RS485 communication B port, and a VCC line 4 is a (+) voltage reference of the power supply circuit, in a conversion module, a GND line 1 at a left side which is linked with the Finger vein 2 module is a (−) voltage reference, an A line 2 is a serial communication standard RS485 communication A port, a B line 3 is a serial communication standard RS485 communication B port, and a VCC line 4 is a (+) voltage reference, in the conversion module, a DI line 5 at a right side is an RS232 serial communication reception port, an RE line 6 is an RS485 communication control port, a DE line 7 is an RS485 communication control port, and an RO line 8 is an RS232 serial communication transmission port, which is linked with the integrated module, a Finger vein 1 authentication code output from the Finger vein 1 module and a Finger vein 2 authentication code output from the Finger vein 2 module are received in the integrated module, and when an authentication code of the Finger vein 1 matches an authentication code of the Finger vein 2, the corresponding authentication codes are output via USB.
